(19) United States
(12) Patent Application Publication
(10) Pub. No.: US 2026/0147780 A1
(43) Pub. Date: May 28, 2026

(54) TAXONOMY-DRIVEN MULTIPASS EXTRACTION OF STRUCTURED DATA FROM UNSTRUCTURED DOCUMENTS

(71) Applicant: Centari, Inc., New York, NY (US)

(72) Inventors: Kevin Philip Walker, New York, NY (US); Junyuan Lau, Oakland, CA (US); Rebecca Naomi Swalve, San Francisco, CA (US); Oleksii Shuliak, Batumi (GE); Melvin Chien Yee Mok, Singapore (SG)

(21) Appl. No.: 19/402,153

(22) Filed: Nov. 26, 2025

Related U.S. Application Data
(60) Provisional application No. 63/725,332, filed on Nov. 26, 2024.

(51) Int. Cl. G06F 16/25

(52) U.S. Cl. CPC G06F 16/258

(57) ABSTRACT

An intelligent document analysis platform transforms unstructured documents into structured, searchable data by aligning them with a domain specific taxonomy. The system may segment each document into snippets, store vector embeddings and use a structure map to target key sections. For every datapoint defined in the taxonomy, the platform may automatically retrieve semantically similar snippets, construct prompt to a language model and extracts candidate values with supporting citations. A normalization phase may resolve conflicts and enforce categorical answer formats, while confidence scores may guide iterative refinement and fallback strategies. Users may receive normalized datapoints with highlighted citations via an interactive interface, and the platform can logs feedback to refine future extractions.

### CROSS REFERENCE TO RELATED APPLICATION

This application claims the benefit of, and priority to, U.S. Patent Application Ser. No. 63/725,332, filed Nov. 26, 2024, the content of which is incorporated by reference in its entirety.

### TECHNICAL FIELD

The present disclosure relates to computer-implemented systems for transforming unstructured documents into structured data using domain-specific taxonomies and multipass artificial intelligence (AI) pipelines, and for enabling comparative editing and propagation of extracted datapoints across multiple document sets.

### BACKGROUND

Service operators that process large volumes of legal and financial documents increasingly turn to machine learning techniques to extract critical datapoints. However, current systems often impose significant burdens on computing resources. Many document analysis engines treat every new document as an isolated, full text problem, repeatedly scanning entire files with large language models or fixed rule sets for each datapoint, regardless of document structure or complexity. This one size fits all approach leads to excessive compute cycles, increased latency and heavy network traffic as models are invoked multiple times for the same portions of text. Such conventional systems generally reprocess lengthy files on each query, consuming storage space for redundant intermediate data and expending bandwidth to shuttle full documents or large contexts to and from AI services.

Additionally, existing extraction workflows lack mechanisms to adapt based on input complexity, causing inefficiencies when handling widely varying inputs (e.g., short agreements versus long, multi party contracts including large set of related, cross-cited documents). These existing workflows perform unnecessary passes that burn CPU and memory resources, or conversely halt too soon, leading to incomplete data and defeating the purpose or accuracy of automation. The technical challenges of managing compute, storage and bandwidth resources in a scalable, reliable way underscore the need for improved architecture for document analysis.

### BRIEF DESCRIPTION OF THE DRAWINGS

FIG. 1 illustrates an example system environment for an intelligence platform, in accordance with one or more embodiments.

FIG. 2A is a block diagram of an intelligence platform, in accordance with one or more embodiments.

FIG. 2B is a block diagram of an extraction orchestrator of the intelligence platform, in accordance with one or more embodiments.

FIG. 2C is a block diagram of a comparative editing module of the intelligence platform, in accordance with one or more embodiments.

FIG. 3 is a data flow diagram showing the processing of unstructured documents, in accordance with one or more embodiments.

FIG. 4 illustrates the mapping between unstructured documents, a domain-specific taxonomy and corresponding document snippets, in accordance with one or more embodiments.

FIG. 5 is a sequence diagram illustrating an example series of interactions among components of an intelligence platform to perform an adaptive multipass extraction, in accordance with one or more embodiments.

FIGS. 6A-6H are screen diagrams illustrating example user interfaces of an intelligence platform, in accordance with one or more embodiments.

FIG. 7 is a flowchart for a method for extracting structured data from a set of one or more unstructured documents, in accordance with one or more embodiments.

FIG. 8 is a flowchart for a method for comparative editing of datapoints across document sets, in accordance with one or more embodiments.

FIG. 9 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated may be employed without departing from the principles described herein.

### Configuration Overview

This disclosure pertains to an intelligent platform that receives unstructured documents, applies a domain specific taxonomy to extract meaningful datapoints and presents the results through an interactive user interface. The platform may be hosted on an application server that communicates with client devices over a network. Users upload documents and specify a taxonomy that defines the datapoints of interest. The platform may then orchestrate intelligent processing of the documents using a combination of embedding, search and language model techniques and store intermediate and final results in dedicated data stores.

Upon receipt of a document set, the platform may divide each document into smaller snippets and generate a semantic vector representation for each snippet using an embedding model. These vector representations and their positional metadata may be stored in a vector database so that subsequent searches can locate relevant passages without having to reprocess the full text. A structure identification phase may use extraction instructions from the taxonomy or heuristics to map the high-level sections of the documents such as definitions, recitals and signature pages. This map allows later phases to focus only on sections that are likely to contain the desired datapoints.

For each datapoint defined in the taxonomy, the platform may perform a candidate extraction phase. It may derive a search vector from the description of the datapoint, apply the structure map to limit the search to relevant sections and retrieve the most similar snippets from the vector database. These candidate snippets may be sent to a large language model (LLM) along with a prompt derived from the taxonomy to produce one or more candidate values and citations to the source text. The intelligent platform may compute a confidence score based on the extracted candidate values. If the score is below a threshold, the platform may automatically and programmatically take steps such as adjusting the search criteria for the semantic search, adjusting the prompt to the LLM, choosing a different or fallback LLM, and the like. The platform may thus automatically and programmatically modify or repeat steps of the extraction pipeline until satisfactory confidence is achieved. Once an acceptable set of candidate values is obtained, a normalization phase may resolve any conflicting values and standardize formats before storing a final value and its citations in a structured datastore. By segmenting documents once, reusing vector embeddings and dynamically scheduling the number of passes based on document complexity and confidence, the platform may reduce unnecessary computation, storage and network usage compared with systems that repeatedly scan entire documents.

In addition to extracting datapoints, the platform may facilitate comparative editing across multiple document sets. After the structured data has been generated for a document set, the user interface of the platform may enable a user to interact with the extracted datapoints in a table or chart and compare different document sets (e.g., a current deal and a past similar deal) at the extracted datapoint level so that differences in values can be easily identified. The intelligent platform may further enable smart editing functionality in such a comparison interface so that when a user selects a preferred value from a dynamically generated dropdown (which may include a value for a selected datapoint from the other document set), the platform may locate every occurrence of that datapoint in the current document set using the stored citations and positional metadata. It may then automatically replace or modify the text corresponding to each occurrence based on the selected value for the datapoint, update the structured data accordingly and store versioned copies of the documents in the set for audit and roll back. If a datapoint so modified using the comparison interface has dependent data points, the platform may automatically trigger a re-extraction process to ensure that related values remain consistent with the extraction metadata defined by the corresponding taxonomy.

The intelligence platform thus provides a comprehensive solution for transforming unstructured documents into reliable, structured data and for using that data to streamline document comparison and editing workflows. By integrating vector databases, adaptive multipass extraction, confidence-based scheduling and automated propagation of user selected changes, the intelligence platform alleviates the computational and bandwidth burdens associated with large scale document analysis while enhancing accuracy, transparency and user productivity.

### Example System Environment

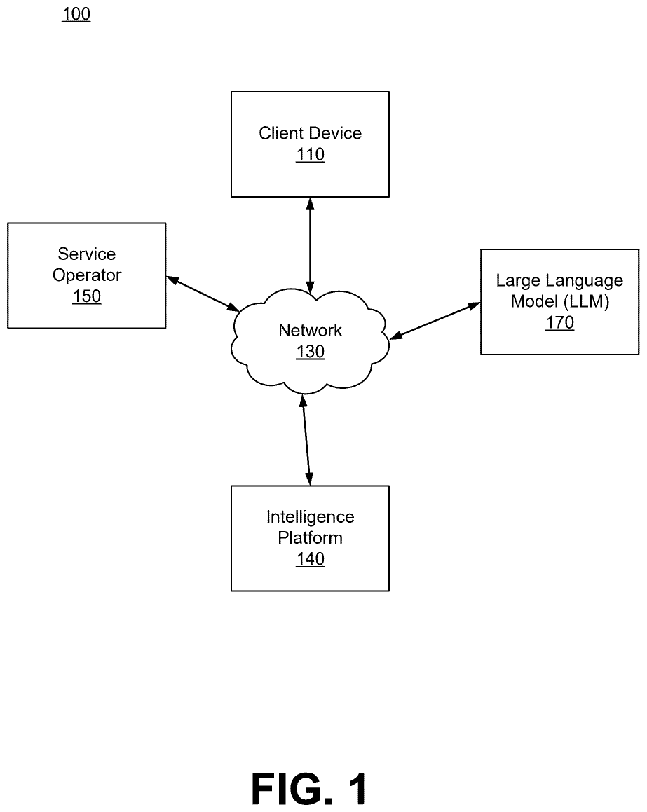

FIG. 1 illustrates an example system environment 100 for an intelligence platform 140, in accordance with one or more embodiments. The system environment 100 illustrated in FIG. 1 includes a client device 110, network 130, an intelligence platform 140, a service operator 150, and a large language model (LLM) 170. Alternative embodiments may include more, fewer, or different components from those illustrated in FIG. 1, and the functionality of each component may be divided between the components of the environment 100 differently from the description below. Additionally, each component may perform their respective functionalities in response to a request from a human, or automatically without human intervention. While one client device 110, one service operator 150, and one LLM 170 are illustrated in FIG. 1, any number of client devices, service operators, and LLMs may interact with the intelligence platform 140. As such, there may be more than one client devices 110, service operators 150, or LLMs 170.

The client device 110 is a computing device through which a user interacts with the intelligence platform 140. In various embodiments, the client device 110 may be a smartphone, tablet computer, laptop computer or desktop computing device. A user may employ the client device 110 to upload documents, select, edit or create a domain-specific taxonomy and initiate extraction operations. The client device 110 may execute a native application or display a web based interface that communicates with the intelligence platform 140 via application programming interfaces. Through the interface, the user can navigate taxonomy definitions, monitor the progress of extraction, view structured datapoints with citations and interact with graphical elements such as tables, charts and timelines.

In certain workflows, the client device 110 may enable a user to perform comparative editing between multiple document sets. For example, a user reviewing a current contract and a previous contract may employ the comparative view on the client device 110 to select a preferred value for a datapoint based on datapoint values in the earlier agreement. The interface allows the user to highlight extracted datapoints, click on available alternative values presented in a drop down menu and trigger automated updates to the underlying documents. The client device 110 also supports exporting structured data in various formats such as spreadsheets or database records and may present visualizations that assist the user in understanding trends across multiple matters.

The service operator 150 represents an entity, such as a law firm, financial services firm or corporate legal department, that subscribes to the intelligence platform 140 to streamline document review and analysis tasks for its professionals. Each operator 150 may maintain its own tenant or account within the platform and provide authentication credentials so that authorized users, e.g., attorneys, analysts, paralegals and other staff, can access the functionality provided by the platform 140 through client devices 110. During onboarding, the operator 150 may configure a dedicated instance of the platform 140 tailored to its domain specific requirements. For example, an operator may define custom taxonomies for mergers and acquisitions agreements or credit facilities, specify preferred answer formats, upload sample documents for training and set parameters governing how the platform 140 segments and processes documents. The operator 150 may also furnish integration endpoints so that the platform can store extracted data in the operator's document management system, customer relationship management database or compliance repository.

The operator 150 may use a management console or application programming interface to administer users, manage matters and configure extraction workflows. Through the user interfaces provided by the platform 140, authorized users of the operator 150 can create new matters, assign matter identifiers, upload document sets and select the appropriate taxonomies for extraction. The platform 140 may also enable functionality to enable administrative users of the operator 150 to configure global settings associated with an instance of the platform 140 corresponding to the operator 150. For example, the global settings configurable by the administrative user of the operator 150 may include settings for taxonomy creation or modification, search scope, model selection and confidence thresholds, dependencies among datapoints or categories of documents to be processed. In some embodiments, the operator 150 may integrate the platform 140 with single sign on systems for user authentication and with internal analytics tools for reporting on extracted data. Some implementations may allow the operator 150 to provide feedback on extraction results and to submit corrections or annotations that the platform 140 may use to refine its extraction models and prompts over time. By exposing its internal processes and data sources to the platform 140 and configuring extraction parameters, the service operator 150 may act as a resource provider that enables the automated document analysis and comparative editing flows of the intelligence platform 140.

The large language model (LLM) 170 represents one or more machine learned models that the intelligence platform 140 may employ to interpret natural language content and extract or normalize datapoint values in response to prompts. In various embodiments, these models are large language models trained on extensive corpora of text such as contracts, statutes, technical manuals and diverse linguistic content to perform tasks including question answering, classification, summarization and semantic pattern matching. The models typically represent input sequences as tensors and apply deep transformer networks to compute contextual representations and predict subsequent tokens or labels. When invoked by the platform 140, a language model may receive a prompt constructed from the taxonomy metadata and one or more snippets retrieved from the vector database, and generate one or more candidate values for a target datapoint along with supporting spans of text. In other cases, the model may process a list of candidate values and produce a normalized value by resolving conflicts and standardizing formats. The number of parameters in such a model can range from hundreds of millions to tens of billions, and running inference may require specialized hardware accelerators.

Due to their size and computational requirements, the language models 170 are often hosted on remote servers or cloud infrastructures operated by third party vendors. The intelligence platform 140 may access these models through secure interfaces, sending prompts and receiving token streams as output. The models may be commercially available services, for example, general purpose chat or completion models, or proprietary models fine tuned using domain specific training data supplied by a service operator. In some embodiments, the platform 140 may employ retrieval augmented generation (RAG): before sending a prompt to the model, it retrieves context relevant to the datapoint from the vector database and appends that context to the prompt so that the model's response is grounded in factual evidence and reduces hallucination. The platform 140 may also select among multiple models based on factors such as latency, cost or accuracy, and may include logic that automatically and programmatically causes an extraction workflow to fall back to a secondary model if the primary model does not produce a result with sufficient confidence. By integrating external language models 170 with local vector search and taxonomy metadata, the intelligence platform 140 leverages advanced natural language processing capabilities while controlling resource consumption and grounding outputs in the underlying documents.

The client device 110, the intelligence platform 140, the service operator 150, and the large language models 170 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The intelligence platform 140 is a computer implemented system that receives unstructured document sets from authenticated users, interprets textual content using deep language models and orchestrates automated workflows to extract and normalize structured datapoints. At a high level, the platform 140 acts as an intermediary between domain experts and the data hidden within complex legal and financial agreements, transforming free form documents into structured records aligned with a user defined taxonomy. The platform 140 ingests uploaded files, segments them into snippets, generates dense vector representations, consults domain taxonomies and curated extraction metadata to determine which sections and terms are relevant and then invokes large language models to identify and normalize datapoint values with supporting citations. It maintains context throughout the extraction process, aggregating results and confidence metrics across multiple passes so that intermediate findings can guide subsequent searches and prompt refinements, thereby producing accurate and reproducible outputs.

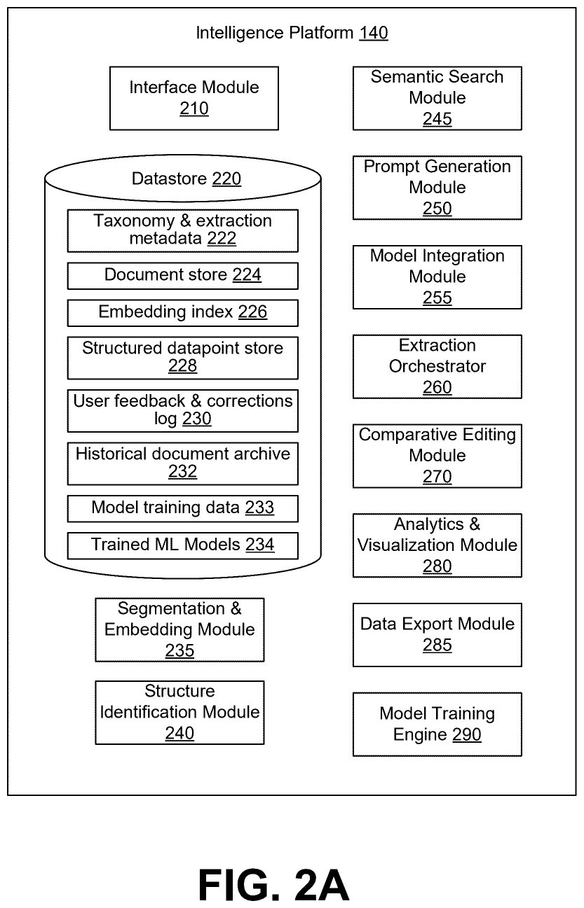

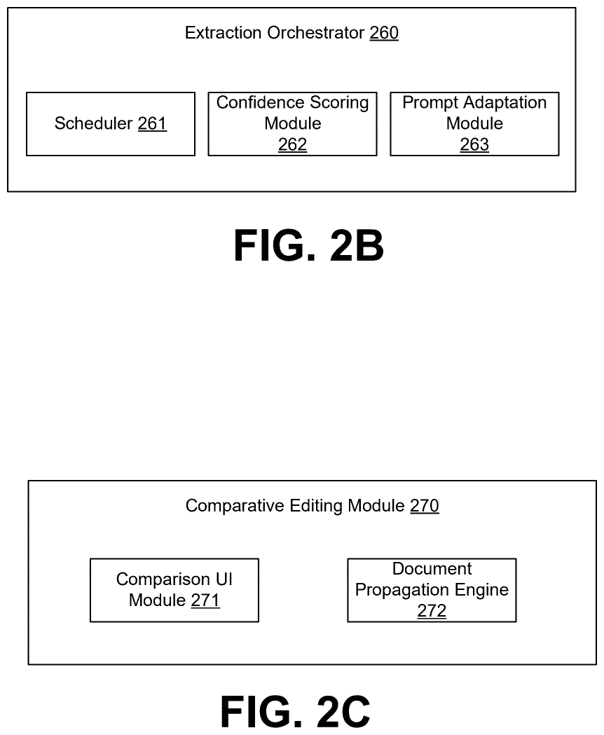

Built using modular components, the platform 140 may employ a segmentation and embedding module to convert raw text into embeddings stored in a vector index, a structure identification module to map the logical layout of documents, a semantic search module to retrieve candidate snippets based on similarity metrics, a prompt generation module to construct context aware queries, and a model integration module to call commercially available external or custom built language models for inference. An extraction orchestrator may coordinate these interactions, performing adaptive multiple passes with confidence scoring, prompt adaptation and fallback model selection. The platform 140 may also include a comparative editing module that displays structured datapoint values from multiple (unrelated) document sets, permits user selection of alternate values and automatically propagates selected changes back into the documents and structured records. Through integration with operator 150 specific data stores and export interfaces, the platform 140 can update back office systems, generate analytics and produce audit trails without manual intervention. More detailed descriptions of the platform's internal architecture and functionality are provided in connection with FIGS. 2A-2C and subsequent figures.

### Example Intelligence Platform

FIG. 2A is a block diagram showing example components of the intelligence platform 140 and the data stored in its datastore 220. The platform 140 may be designed to support multiple service operators 150; when a new operator subscribes, platform 140 may provision a dedicated configuration that includes secure credentials, bespoke taxonomies and extraction metadata, and integration endpoints for the operator's 150 document management system, customer relationship management system and compliance repositories. When an authorized user uploads a document set and selects or creates a matter, platform 140 may initialize a processing context for that matter that persists through segmentation, extraction, normalization and comparative editing. This matter context may be used by the platform's 140 components to accumulate embeddings, candidate snippets, extracted datapoints, user corrections and intermediate confidence metrics. The context also isolates the state of one matter from others while allowing the platform to maintain continuity across multiple user interactions related to the same matter. After processing is complete, the structured results and any relevant audit data may be persisted to the datastore or exported to the operator's 150 systems.

FIG. 2A shows that the intelligence platform 140 includes an interface module 210 for handling user authentication and data transfer, a segmentation and embedding module 235 for slicing documents into snippets and generating vector representations, a structure identification module 240 for determining document sections such as definitions and recitals, a semantic search module 245 for querying a vector index to retrieve relevant snippets, a prompt generation module 250 for constructing prompts to a language model based on candidate snippets and extraction metadata, a model integration module 255 for invoking external or custom language models to extract and normalize datapoint values, an extraction orchestrator 260 for coordinating multipass extraction, confidence evaluation and fallback logic, a comparative editing module 270 for presenting structured datapoints side by side and propagating user selected values across document sets, an analytics and visualization module 280 for generating reports and dashboards from extracted data, a data export module 285 for exporting normalized datapoints to external systems, and a model training engine 290 for fine tuning custom models. The platform's 140 datastore 220 may comprise substores for taxonomies and extraction metadata 222, uploaded documents 224, vector embeddings 226, normalized datapoints 228, user feedback and corrections 230, historical document archives 232, model training data 233 and trained machine learning models 234.

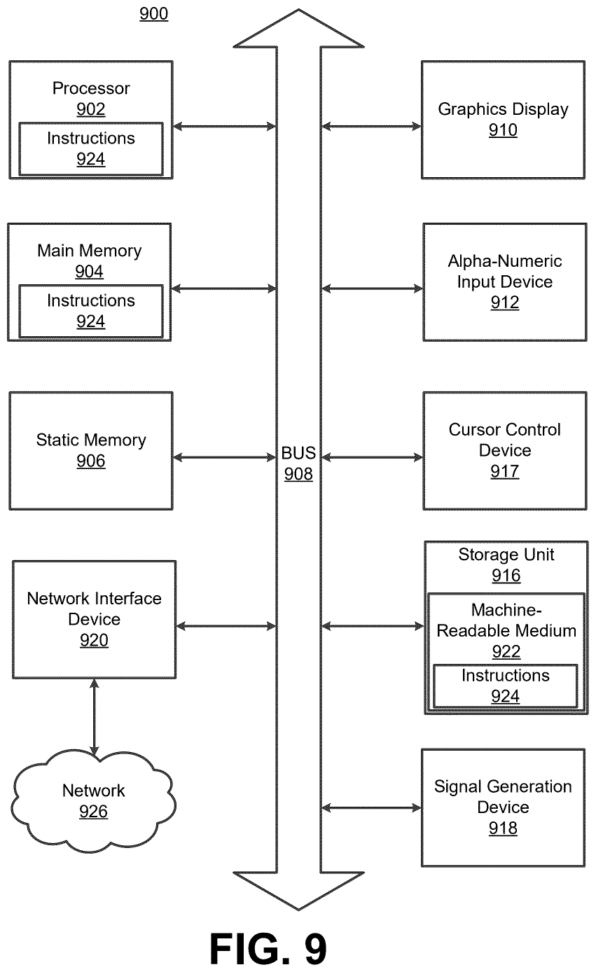

In some embodiments the intelligence platform 140 may include fewer or additional components, and the functions described may be distributed among components differently than described here. The components of the intelligence platform 140 may be implemented as software engines comprising program code stored in memory and executed by one or more processors. Alternatively, some or all components could be embodied in hardware, such as field programmable gate arrays or application specific integrated circuits, which may operate alone or in combination with firmware and software. Each component in FIG. 2A may include all or part of the example structure and configuration of the computing machine described in FIG. 9.

The interface module 210 may act as the gateway for data flowing into and out of the intelligence platform 140. It may implement the transport protocols and session management needed to communicate with client devices 110, service operator systems 150 and external language model services 170 over the network 130. For example, when a user accesses the platform through a web browser or a native application, the interface module 210 may negotiate secure HTTP sessions using Transport Layer Security, authenticate the user via tokens or single sign on mechanisms and present APIs for uploading documents, selecting taxonomies and initiating extraction. It may receive multipart form data containing document files and metadata, verify that the files meet size and format constraints and dispatch them to the downstream modules, e.g., the segmentation and embedding module 235, for ingestion and extraction. The interface module 210 may also handle real time streaming of progress updates, sending notifications to the client device 110 as extraction passes complete, confidence scores are computed and normalized values for datapoints become available. When the extraction orchestrator 260 triggers calls to external large language models 170 via the model integration module 255, the interface module 210 may serialize prompts and context into a format such as JSON, include operator specific authentication credentials and transmit the request over a secure channel. Upon receiving streaming token outputs from the language model 170, the interface module 210 may buffer the output, ensure order and integrity and forward the results to the orchestrator 260 for further processing.

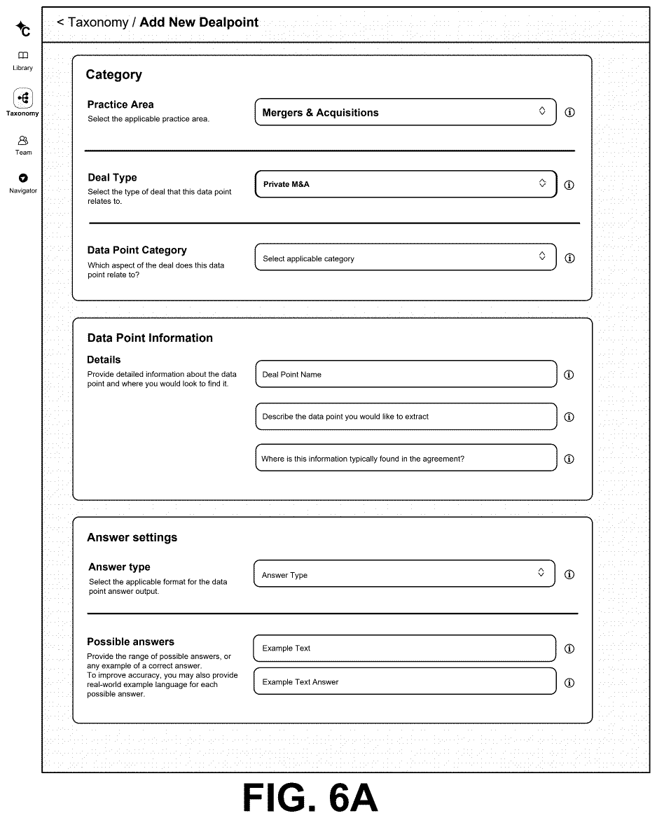

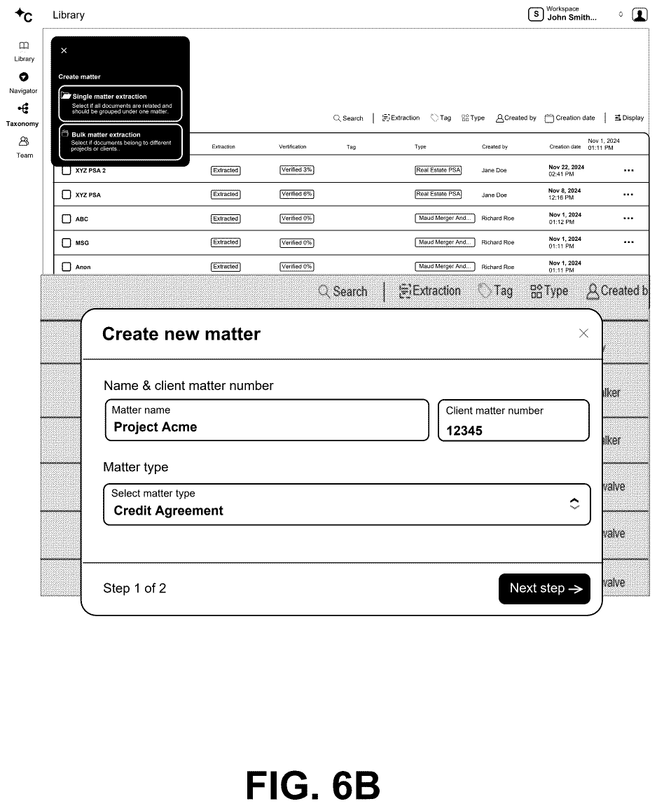

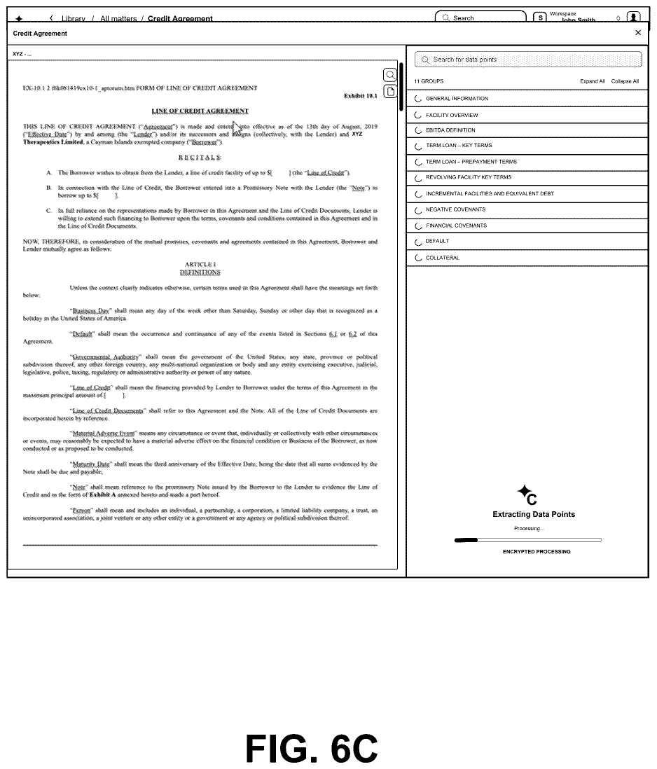

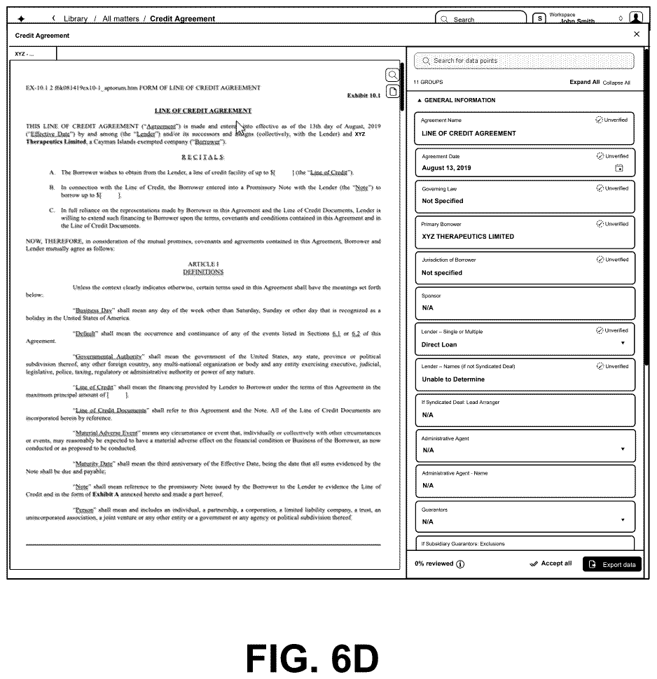

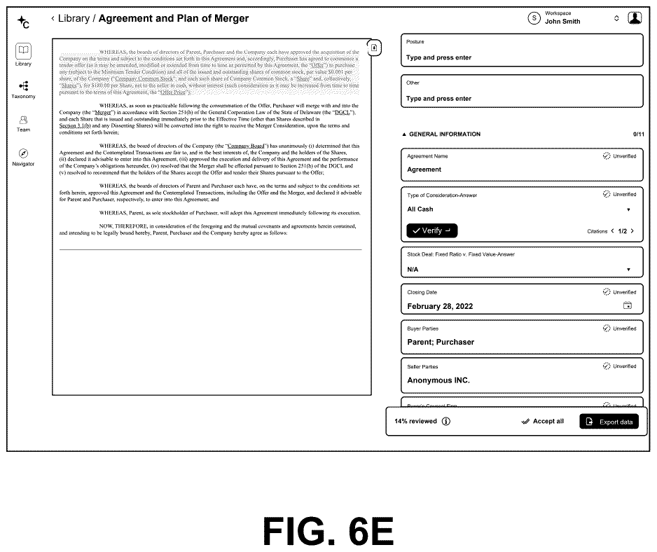

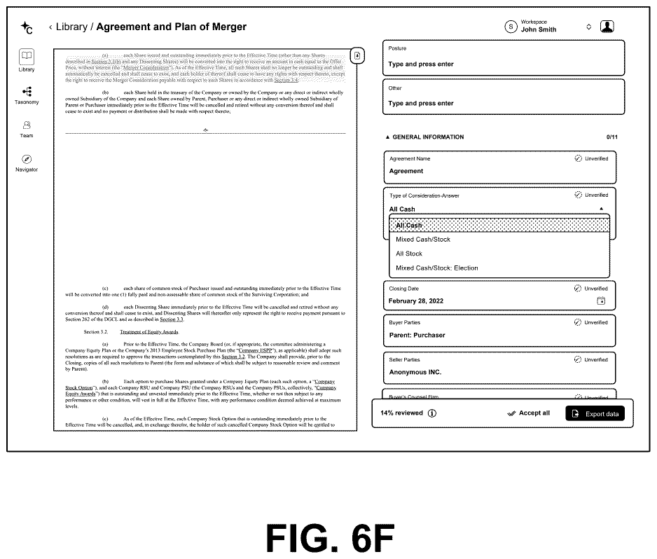

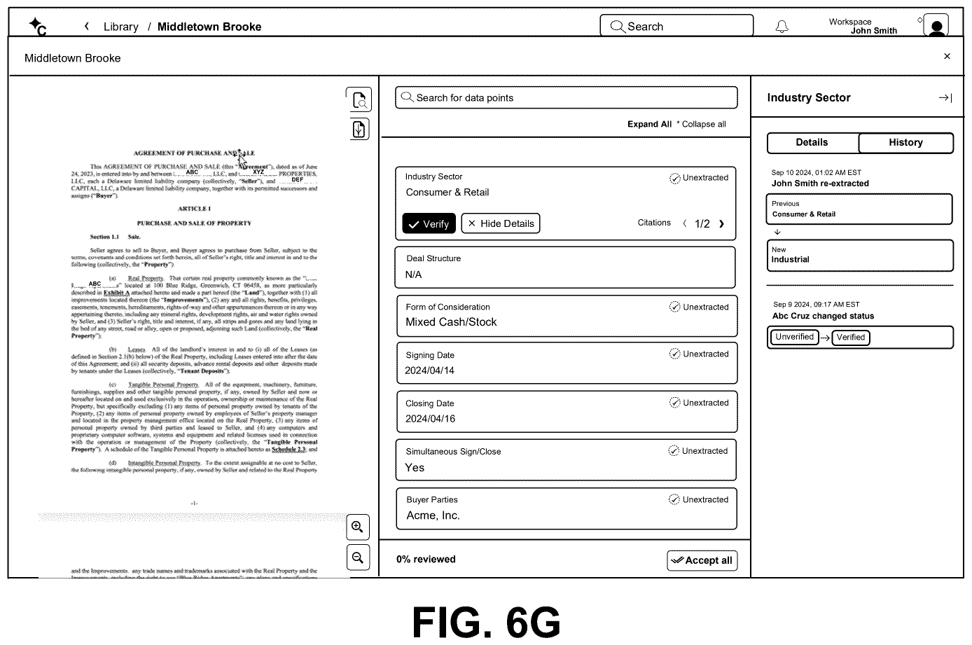

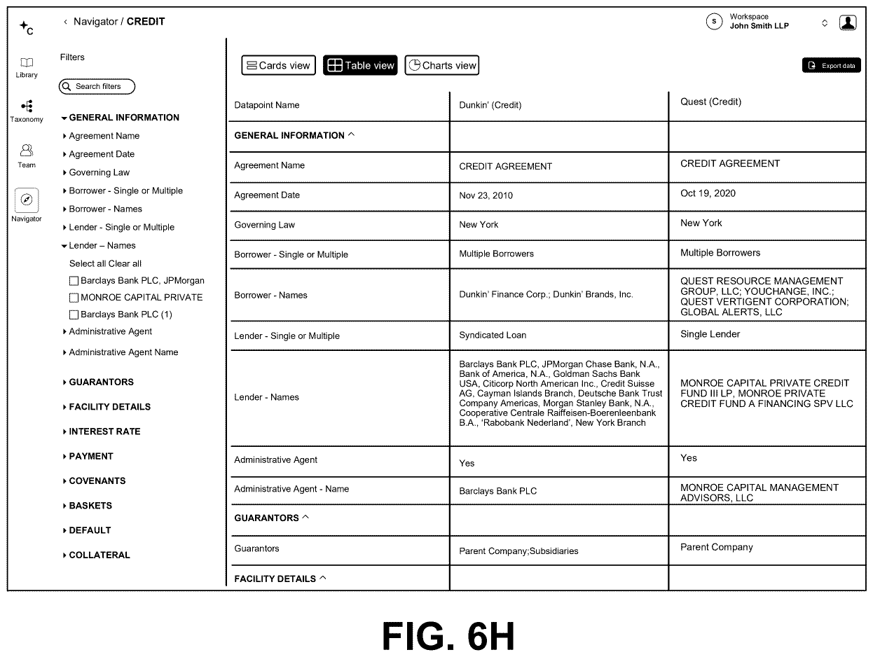

In one or more embodiments, the interface module 210 also renders interactive user interfaces, examples of which are depicted in FIGS. 6A through 6H. These interfaces allow users to create and navigate taxonomies, upload document sets, monitor extraction progress, review normalized datapoints with highlighted citations, choose alternative values from dynamically generated dropdown lists and visualize trends across matters via tables, timelines and charts. Through these interfaces users can initiate comparative edits, trigger exports and inspect edit histories, with the interface module 210 ensuring that user actions are translated into appropriate API calls and that the corresponding updates and visual feedback are presented in real time.

The interface module 210 may also be responsible for interacting with the operator's 150 back end systems and exporting data. It may construct REST or GraphQL requests to document management systems or customer relationship management systems to store normalized datapoints, map internal identifiers to operator specific identifiers and handle responses and error codes. For comparative editing, the interface module 210 may transmit updated document versions and change logs back to the operator's systems and acknowledge receipt. When the analytics and visualization module 280 generates dashboards or reports, the interface module may stream graphical data or files to the client device using websocket or HTTP streaming. It may handle export requests, formatting structured data into CSV or Excel files and uploading them to the client device or to an external system via secure file transfer protocols. In some implementations the interface module 210 may manage authentication and authorization workflows, such as validating that a user has permission to access a particular matter, retrieve sensitive documents or execute a comparative edit. By managing these diverse communication channels, the interface module 210 may ensure that the platform 140 can reliably receive unstructured documents and taxonomy selections, deliver structured results and user interfaces to the client device, and integrate with external language model services and operator systems required to execute the extraction and comparative editing workflows described herein.

The datastore 220 may hold persistent data used by or generated by the platform 140. The taxonomy and extraction metadata store 222 may store domain specific taxonomies, including datapoint definitions, extraction prompts, parent child relationships, categories and allowable answer sets. The document store 224 may hold uploaded unstructured documents or document sets and their versioned updates on a per-matter basis. The embedding index 226 (e.g., vector database) may store vector embeddings and positional metadata for document snippets to support efficient semantic search. The structured datapoint store 228 may contain extracted candidate (intermediate) datapoint values and/or normalized (final) datapoint values with consolidated citations and associated confidence scores. The user feedback and corrections log 230 may record user edits and annotations made via the user interface, which can be used to refine extraction strategies. The historical document archive 232 may store previous versions of documents and matters for auditability. The model training data store 233 may contain labeled examples and corpora used to train or fine tune embedding models, structure detectors and extraction models. The trained machine learning models store 234 may hold serialized weights and configuration files for custom models employed by platform 140. Additional data structures, such as matter contexts, analytics summaries or export records, may also be stored in the datastore 220 to support reporting and compliance.

The segmentation and embedding module 235 may receive documents (e.g., set of unstructured documents) and prepare them for downstream processing by dividing them into discrete snippets and converting each snippet into a numerical representation suitable for semantic search. When the interface module 210 delivers an uploaded document to this module, the segmentation and embedding module 235 may first determine the document type and apply appropriate preprocessing. For native digital formats such as word processing files or PDFs containing extractable text, it may parse the text directly, preserving structural information such as headings, paragraphs, tables and footnotes. For scanned images or documents containing non-selectable text, module 235 may invoke an optical character recognition engine to produce a text layer. In some implementations, module 235 may apply language detection, character set normalization, tokenization and sentence boundary detection to ensure consistent downstream processing.

Once a clean text layer has been obtained, the segmentation and embedding module 235 may partition the document into snippets. A snippet may correspond to a paragraph, a portion, a clause, a table row or another logical unit of text. Module 235 may employ rule based heuristics (for example, splitting on blank lines, punctuation patterns or markup tags) and, in some embodiments, machine learning models trained to identify boundaries between clauses or sections in legal and financial documents. For each snippet the module 235 may record positional metadata, such as the page number, character offsets within the original document and any higher-level section identifier produced by the structure identification module 240. This metadata may enable accurate citation and highlighting during datapoint-based document navigation on a user interface.

For each snippet produced by the segmentation process, module 235 may compute a dense vector embedding using an embedding model. The embedding model may be a transformer-based encoder pre-trained on general text corpora and optionally fine-tuned on domain specific materials supplied by the service operator 150. Module 235 may convert the sequence of tokens representing the snippet into a fixed length vector that captures the semantic content of the snippet in a multidimensional space. The resulting vector and its associated positional metadata may be stored as embedding index 226 (e.g., vector database) in the datastore 220. In some embodiments, module 235 may generate multiple embeddings per snippet, such as a more granular sentence level embedding and a more generic full snippet embedding, to support different granularity in search. Module 235 may also compute hash identifiers and store references to the corresponding text or PDF objects in the document store 224. By generating embeddings once per document or document set and storing them in the index 226, the platform 140 may avoid recomputing embeddings on subsequent passes and reduce both computational load and latency.

The segmentation and embedding module 235 may also attach additional metadata to each snippet. For example, it may classify the snippet by file type category, language or potential relevance to specific datapoints based on keyword matches or simple pattern recognition. It may flag snippets that contain tables or exhibits and extract structured representations of those tables for separate processing. When the document includes multiple related files, such as exhibits or attachments, module 235 may maintain references linking snippets across files. This metadata may allow the semantic search module 245 to apply filters based on operator configured categories or structure maps and enables the platform to efficiently retrieve candidate snippets during the candidate extraction phase. Through these operations, the segmentation and embedding module 235 may enable efficient, scalable extraction of structured datapoints and subsequent comparative editing.

The structure identification module 240 may utilize the snippets and associated positional metadata generated by the segmentation and embedding module 235 and stored in the index 226 to produce a structure map that identifies the logical organization of each document. In many legal and financial documents the placement of key information is dictated by conventions: definitions often appear in a dedicated section near the beginning, recitals and background clauses precede operative provisions, representations and warranties appear in separate articles and signature pages conclude the document. Recognizing these patterns may allow the platform 140 to limit subsequent search and extraction to relevant sections, thereby reducing computational load. The structure identification module 240 may employ one or both of rule based techniques and machine learning to detect these structural boundaries.

In some embodiments, module 240 may use heuristics derived from document formatting and typographical cues. It may scan the text of each snippet for common section headings, such as “Definitions,” “Recitals,” “Governing Law,” “Representations and Warranties,” “Termination,” “Signature Page” or “Schedule,” and record the snippet indices where these phrases appear. It may examine capitalization patterns, numbering schemes and indentation to infer hierarchical relationships between headings and subheadings. For example, an all-caps heading followed by a centered title and Roman numerals may indicate the beginning of a major article. The module 240 may also parse table of contents sections if present, correlating the listed section titles and page numbers with snippet positions. When a document lacks clear headings, the module 240 may fall back to heuristics based on key phrases within the text (e.g., “as used herein” for definitions or “This Agreement shall be governed by” for governing law).

To handle variations in drafting styles and to improve accuracy, some implementations of the structure identification module 240 may include a machine learning classifier. A training dataset of annotated contracts and agreements may be used to train a sequence model, such as a transformer encoder or a conditional random field, to label each snippet with a section type. The model 240 may consume tokenized text and outputs probabilities for section types defined in the taxonomy. During inference, module 240 can assign a section label to each snippet and smooth the labels based on document flow. Module 240 may then aggregate contiguous snippets with identical labels into larger regions and record the start and end positions of each region.

The output of the structure identification module 240 may be a structure map for each document. The map may list predefined section types from the taxonomy and associates each type with one or more ranges of snippets. These ranges may reference the snippet indices and include positional metadata such as page numbers and character offsets. The map may also include confidence scores for each section boundary and links to any cross references found in the text (e.g., if a signature block refers to exhibits). This structure map may be stored in the datastore 220, either as part of the matter context or in a dedicated structure map store, and may be made available to the semantic search module 245 and the extraction orchestrator 260. By providing a structured representation of the document layout, the structure identification module 240 may enable later phases to narrow candidate searches to high probability regions, to prioritize snippets from authoritative sections such as definitions and to skip datapoint extraction passes when the structure map indicates that a relevant section is absent.

The semantic search module 245 may perform vector based retrieval of document snippets to supply context for datapoint extraction. When the extraction orchestrator 260 initiates a candidate extraction phase, it may provide the semantic search module 245 with a query embedding representing the semantic intent of the current datapoint and, in some cases, a set of search criteria derived from the structure map produced by the structure identification module 240. The query embedding may be generated by encoding the datapoint's description and related prompt text using the same embedding model employed by the segmentation and embedding module 235, ensuring that the query and document snippets reside in the same vector space. Upon receiving the query embedding, the semantic search module may access the embedding index 226 and execute a similarity search using, e.g., an approximate nearest neighbor algorithm, such as hierarchical navigable small world graphs or product quantization based indexing, to identify embeddings of snippets whose semantic content is most similar to the query.

The search module 245 may apply multiple filters to narrow or prioritize candidates. It may restrict the search to snippets whose positional metadata falls within certain regions of the document defined by the structure map (for example, limiting the search to the definitions section or to signature pages), or to snippets whose metadata indicates they belong to a particular file category specified in the extraction metadata 222. It may exclude snippets previously matched to other datapoints if the extraction logic dictates such exclusivity. The module may also vary the number of neighbors returned based on configuration parameters such as a candidate count defined for the datapoint. When multiple candidate snippets are retrieved, the module 245 may optionally merge overlapping or adjacent snippets according to a merge strategy defined in the extraction metadata, such as concatenating contiguous snippets or selecting the snippet with the highest similarity score. The semantic search module 245 may return the candidate snippets and their associated metadata (including similarity scores and positional information) to the orchestrator, which may use them to construct prompts for the language model. If no candidates satisfy the initial criteria, module 245 may iteratively broaden the search scope by relaxing structure filters or lowering similarity thresholds, thereby supporting the adaptive behavior described for the extraction pipeline.

The prompt generation module 250 may construct input sequences for language model inference based on candidate snippets retrieved by the semantic search module 245 and extraction metadata 222 defined in the corresponding taxonomy. For example, for each datapoint, the extraction metadata may include a base prompt template, example answer formats, directives to enforce categorical answers, parent-child dependencies and fallback strategies. Upon receiving a list of candidate snippets and their citations, the prompt generation module 250 may concatenate the content of the snippets, inserts delimiters or context markers and combines them with the base prompt template to form a complete prompt. The module 250 may preserve the order of snippets or sort them by similarity score, and may include only a subset of snippets when a candidate count limit is specified. The prompt may instruct the language model to extract the target datapoint value (e.g., one or more candidate values), provide the answer in a specified format, cite the supporting text and adhere to any categories or regular expressions defined in the extraction metadata 222. In some implementations the prompt generation module may also include the structure map or summary of document sections to orient the model.

The prompt generation module 250 may support adaptive prompting based on intermediate results. For example, if the extraction orchestrator 260 determines that the candidate values returned by the language model for a particular datapoint have low confidence or conflicting information, it may instruct the prompt generation module to refine the prompt. Refinement may involve narrowing the context, e.g., by including only snippets from certain document sections or excluding snippets that contributed to noise, adding more explicit instructions, such as “if multiple names are found, select the one following the term ‘Borrower means’,” or modifying the answer format to align with a predefined category. The module 250 may also generate fallback prompts when the initial prompt yields no answer, for example by broadening scope or by explicitly asking the model to infer the value from related terms. In some embodiments the prompt generation module 250 may maintain a library of alternative prompts and select an appropriate one based on rules encoded in the extraction metadata 222.

The model integration module 255 may manage the interaction between the intelligence platform 140 and external or custom language models used for extracting and normalizing datapoint values. It may receive prompts from the prompt generation module 250 and determine which language model to invoke based on the extraction metadata 222 and system configuration or instructions provided by the orchestrator 260. The metadata may specify a primary model and one or more fallback models for each datapoint. The model integration module 255 may package the prompt into the format required by the selected model service, attach authentication tokens and send the request over a secure channel. If the model supports streaming outputs, the module 255 may handle partial responses, reconstruct the complete output sequence and pass it to the extraction orchestrator 260 as soon as sufficient information is available. It may record latency and cost metrics for each call, which may inform future scheduling or model selection decisions.

When the extraction orchestrator 260 signals that the initial model output does not meet a confidence threshold, the model integration module 255 may automatically invoke a fallback model. The fallback model may be a smaller, faster model trained on similar data, a domain specific model maintained by the operator or a different commercially available model with complementary strengths. The module 255 may ensure that fallback invocations are traceable and that outputs from different models are tagged accordingly. It may also coordinate with the prompt generation module 250 to adjust the prompt for the fallback call, such as simplifying language or focusing on alternative context. The model integration module 255 may manage multiple concurrent model calls and implement rate limiting or queuing to comply with provider usage limits. By encapsulating model selection, authentication, request formatting and response handling, the model integration module 255 may provide a consistent interface to heterogeneous language models while enabling the adaptive, multipass extraction pipeline described herein.

The extraction orchestrator 260 may act as a central controller that manages multipass extraction workflow for each datapoint defined in a selected taxonomy. In some embodiments, the orchestrator 260 may receive input from the interface module 210 indicating which taxonomy has been selected for a current set of unstructured documents, access embeddings and structure maps from the datastore 220 for the current set, and interact with the semantic search module 245, prompt generation module 250 and model integration module 255 to perform intelligent, adaptive, multipass extraction. For each datapoint, the orchestrator 260 may initialize a processing context that informs the extraction process and includes the datapoint's configuration parameters (such as candidate count, merge strategy, parent dependencies and categorical constraints) and schedules the sequence of extraction passes. During each pass, the orchestrator 260 may trigger a semantic search to retrieve candidate snippets, generate a prompt from the candidate snippets and extraction metadata, invoke a language model via the model integration module and records the resulting candidate values and citations. The orchestrator 260 may track intermediate confidence metrics and determine whether further passes are required. It may write intermediate and final results to the structured datapoint store 228 and update the matter context so that the progress of each datapoint can be monitored and reviewed. When comparative editing is invoked, the orchestrator 260 may also monitor changes to datapoint values and trigger reextraction of dependent datapoints as necessary.

FIG. 2B illustrates that the extraction orchestrator 260 may be implemented as a collection of submodules, including a scheduler 261, a confidence scoring module 262 and a prompt adaptation module 263. The scheduler 261 may determine the order and number of extraction passes to run for a given datapoint. It may consider document level metrics, such as length, section count and file type, and extraction level metrics, such as the number and similarity of candidate snippets, the existence of parent datapoint values and the distribution of confidence scores from previous passes. Based on these metrics and configurable thresholds, the scheduler 261 may decide to skip the structure identification pass for simple documents, to perform additional candidate extraction passes (to extract candidate values for a datapoint) when confidence is low or conflicting values are returned or to halt further processing when an acceptable answer has been obtained.

The confidence scoring module 262 may evaluate the quality of candidate values produced during a pass. For each candidate value, it may compute a score based on factors such as the cosine similarity between the query embedding and the retrieved snippets, the agreement among multiple candidate values extracted from different snippets or different models, the presence of the candidate value in authoritative sections indicated by the structure map, and adherence to expected formats or categories. Module 262 may combine these factors into a single numeric confidence score using a weighted formula or a dedicated lightweight machine learning model trained on historical extraction outcomes. The orchestrator 260 may use these scores to decide whether the candidate values meet a predetermined threshold and whether additional passes or fallback models should be invoked.

The prompt adaptation module 263 may refine the search criteria and/or prompt content when initial extraction attempts do not yield satisfactory results. For example, based on the output of the confidence scoring module 262 and rules defined in the extraction metadata 222, module 263 may apply modifications such as narrowing the search to a subset of document sections, excluding previously retrieved snippets that introduced noise, adding or removing instructions in the prompt template or selecting a fallback prompt. The module 263 may consult a library of prompt variations and select one based on heuristics, for example, choosing a prompt that looks for explicit definitions when conflicting entity names are found, or a prompt that instructs the model to extract a date using patterns like “Termination Date is.” Once the prompt is adapted or the search criteria has been modified, scheduler 261 may trigger a new extraction pass with the updated parameters. By coordinating the actions of submodules 261-263, the extraction orchestrator 260 may enable adaptive, efficient and reliable extraction of datapoints across a wide variety of document types and complexities.

In some embodiments, the scheduler 261 may dynamically adjust the sequence and number of extraction passes based on document-level and/or extraction-level metrics. For instance, if an initial candidate extraction pass yields a high confidence score for a datapoint (e.g., strong agreement among candidate values and high similarity scores), the scheduler 261 may skip subsequent passes or omit the structure identification pass for similar datapoints. Conversely, for lengthy or complex documents, or when candidate values exhibit low confidence or conflicting results, the scheduler 261 may increase the number of passes, broaden or narrow the search scope in the semantic search module 245, or alter the order of passes to focus on different document sections. The scheduler 261 may also use metadata, such as section count, file type, and distribution of similarity scores, to determine whether to invoke a fallback model. The fallback logic may compare latency, accuracy, cost and domain specificity of candidate models specified in the extraction metadata 222; if the primary model fails to meet confidence thresholds or returns no result, a secondary model fine tuned on domain-specific material or optimized for numeric extraction may be selected. In parallel, the prompt adaptation module 263 may refine prompts by introducing or removing contextual snippets, adding explicit instructions (e.g., to select a value following a particular phrase), or constraining the response format. These adaptive mechanisms may reduce unnecessary computation and improve extraction accuracy across varied document types and complexities.

Once the extraction orchestrator 260 determines, based on the output of the confidence scoring module 262, that the set of candidate values for a datapoint obtained after one or more extraction passes meets or exceeds the predetermined quality threshold, the orchestrator 260 may initiate a normalization pass. In some embodiments, the prompt generation module 250 may construct a succinct normalization prompt that enumerates the candidate values and their supporting citations and specifies any categorical constraints defined in the extraction metadata 222. The model integration module 255 may forward this prompt to the appropriate language model and receive a response containing a single normalized value and consolidated citations. The extraction orchestrator 260 may record this normalized value and its citations in the structured datapoint store 228, update the matter context and proceed to the next datapoint or returns the result for display.

After datapoint extraction and normalization as described above is completed for a plurality of datapoints defined in the taxonomy, the comparative editing module 270 may enable users to leverage structured datapoints and respective normalized values extracted from multiple document sets (e.g., past and current deals) to streamline drafting and negotiation tasks. In some embodiments, module 270 may interface with the structured datapoint store 228, with the user interface rendered by the interface module 210, and with the document store 224. When a user selects two or more matters for comparison, the comparative editing module 270 may retrieve the normalized datapoint values and citations for each selected matter and construct a unified comparison view (FIG. 6H). Module 270 may align datapoints by their taxonomy codes, allowing the user to filter or sort datapoints by category or importance and highlights values (for a same datapoint) that differ between the matters. It may also compute summary statistics or visual indicators showing how many datapoints differ or match.

As shown in FIG. 2C, the comparative editing module 270 may include a comparison user interface module 271 and a document propagation engine 272. The comparison user interface module 271 may be responsible for presenting structured datapoint values from multiple document sets in a tabular or graphical format. For each datapoint row, it may display the value extracted from each matter alongside any predefined categories, units or descriptive labels. When the user hovers over or clicks on a value, module 271 may retrieve the associated citation metadata and trigger the interface module 210 to display the corresponding snippet within the original document. If a datapoint has multiple candidate values in a given matter (for example, where the value is not yet normalized), the comparison UI may present these candidates as alternatives in a drop-down menu or similar control. Module 271 may track which datapoint and matter the user is currently editing and communicate the selection to the document propagation engine 272.

The document propagation engine 272 may receive an instruction to update a specific datapoint in a target document set with a selected candidate value, which may be identified as a value based on occurrence in another document set. Using the positional metadata stored in the citation associated with the datapoint in the target document, the engine 272 may locate every occurrence of the current value for the specific datapoint in the underlying document set. It may parse the document's text or markup to ensure that replacements are only made in relevant contexts (e.g., within defined terms or schedule entries) and may apply formatting rules to match the style of the original text. Engine 272 may replace the identified segments with the selected value, update the normalized datapoint value in the structured datapoint store 228 for the document set and write a new version of the document to the document store 224. It may also log the change in the user feedback and corrections log 230, including details such as the user identity, timestamp and rationale. If the updated datapoint has dependent datapoints defined in the taxonomy, engine 272 may notify the extraction orchestrator 260 to reextract those dependent datapoints using the updated document context. The engine 272 may provide a preview to the user before finalizing changes and may offer undo functionality by referencing the historical document archive 232. Through these coordinated actions, the comparative editing module 270 may enable efficient cross matter comparisons and consistent propagation of selected values across document sets.

The analytics and visualization module 280 may consume normalized datapoint values, citations and confidence scores from the structured datapoint store 228 and compute aggregated statistics and trends across matters. It may derive metrics such as frequency distributions, averages and variance for each datapoint, compare values across document sets, highlight deviations from norms, and assemble data structures for interactive dashboards, charts and tables rendered by the interface module 210. By cross-referencing positional metadata in the embedding index 226 and incorporating user corrections from log 230, it may enables users to explore patterns, monitor extraction quality and drill down from high-level analytics to the underlying snippets without reprocessing the source documents.

The data export module 285 may package structured datapoints, citations and version metadata into formats such as CSV, spreadsheet workbooks or JSON for download or integration into external systems. For each datapoint, the export may include the normalized value, supporting snippet locations in the document store 224, confidence scores and timestamps, and when comparative edits have occurred, both current and prior document versions referenced from the historical archive 232. The module 285 may interact with the interface module 210 to transmit files to the client device 110 or to post payloads to operator-specified endpoints, log export operations in the corrections log 230, and may notify downstream systems via webhooks when new or updated datapoints are available.

The model training engine 290 may provide pipelines for training, fine-tuning and evaluating machine learning models used by the platform. It may ingest labeled examples, taxonomies, prompts and user generated corrections from the training data store 233 and persist updated model weights and configurations to the trained model store 234. The engine 290 may retrain embedding encoders for the segmentation and embedding module 235, classifiers for the structure identification module 240, similarity models for the semantic search module 245 and prompt generation heuristics for module 250, as well as fine tune custom language models used by the model integration module 255.

Feedback from live deployments, such as corrected datapoint values and refined prompts recorded in the corrections log 230, can be incorporated into the training data so that models learn from real-world usage and improve recognition of domain specific patterns. Once training completes, the engine 290 may register the model with metadata describing the training set, hyper-parameters and evaluation metrics, enabling the extraction orchestrator 260 to deploy the updated model or revert to earlier versions if confidence scores degrade. The model training engine 290 may expose user interfaces and APIs for operators to schedule training jobs, monitor progress and review reports, supports multi-tenant isolation when fine-tuning models for different operators 150, and enforce safeguards to prevent cross-contamination of proprietary data.

For example, to develop a model capable of extracting candidate values and selecting a normalized answer, the model training engine 290 may draw on a corpus of annotated document snippets stored in the model training data store 233. Each training example may include a snippet of unstructured text, metadata linking the snippet to a datapoint defined in the taxonomy, one or more candidate values identified within the snippet, and the correct normalized value selected by domain experts. During training, the engine 290 may preprocess these examples, tokenize the text and embed the candidate values so that the underlying model learns to detect semantic patterns indicative of a datapoint and to rank or synthesize candidate values. It may then fine tune the model's parameters using supervised learning so that the model can, given a set of candidate snippets and extraction metadata, generate candidate values and subsequently output a single normalized value that conforms to the taxonomy's allowable formats. Once trained and registered in the trained models store 234, this model can be invoked by the extraction orchestrator 260 via the model integration module 255 to produce candidate values and normalized datapoint values for new document sets in a manner consistent with the adaptive, multipass workflow described in the specification.

In some implementations, the intelligence platform 140 may use the user feedback and corrections log 230 not only to record individual edits but also to drive continuous improvement of the extraction pipeline. The platform 140 may aggregate corrections from multiple matters, analyze recurring patterns, such as frequent overrides of a particular datapoint's extracted value, consistent selection of alternative candidate values, or repeated user edits to the same prompt template, and automatically propose modifications to the extraction metadata 222 or the taxonomy. For example, if users repeatedly choose a candidate value from a section that was not initially included in the search scope, the platform 140 may expand the search criteria or adjust structure map parameters for that datapoint. If new categorical answers are frequently entered, the system may suggest updating the allowable answer set for that datapoint. These proposed refinements may be surfaced to domain experts for approval and then incorporated into the model training engine 290's training data, enabling the engine to update embedding models, classification models and prompt templates. This iterative feedback loop may allow the platform 140 to adapt over time to evolving document types and user expectations without requiring extensive manual reconfiguration.

### Example Processing Pipeline for Processing of Unstructured Documents

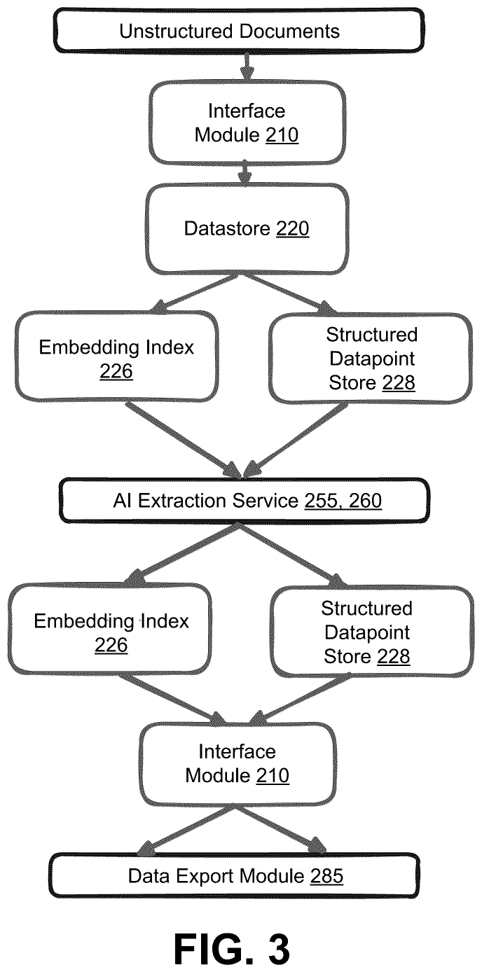

Referring to FIG. 3, a data flow diagram illustrates the processing pipeline by which the intelligence platform 140 transforms unstructured documents into structured datapoints. In an initial stage, a set of unstructured documents is received via the interface module 210, which accepts files uploaded from client devices 110 and persists the raw content and associated metadata to the datastore 220. The datastore 220 may maintain both an embedding index 226, comprising semantic vector representations and positional information for each document snippet, and a structured datapoint store 228, which will ultimately hold candidate and normalized values along with supporting citations. Splitting the unstructured documents into these two parallel data structures enables the platform to avoid reprocessing the same text during subsequent passes and to provide both candidate context and final results for downstream modules.

The AI extraction service (which may include the model integration module 255 and the extraction orchestrator 260 of the platform 140) may operate on the datastore 220 to extract and normalize datapoints defined by a domain specific taxonomy. FIG. 3 shows that during a candidate extraction pass, the extraction orchestrator 260 may retrieve embeddings from the embedding index 226, performs a semantic similarity search using query embeddings derived from the extraction metadata 222 and, in some embodiments, the structure map, and invoke the model integration module 255 to call an external or custom language model. The model integration module 255 may return candidate values and citations, which may be written to the structured datapoint store 228 and scored for confidence. If confidence is insufficient, the orchestrator 260 may adapt the search scope, prompt template or selected model and perform further passes; when a satisfactory set of candidate values is obtained, the orchestrator 260 may schedule a normalization pass to synthesize a single normalized value, which may be stored alongside its consolidated citations.

Once the AI extraction service has populated the structured datapoint store 228 with normalized values, the interface module 210 may retrieve the structured results and deliver them to the data export module 285. The data export module 285 may package the normalized datapoint values, corresponding citations and any version metadata into user selected formats (such as CSV, spreadsheets or JSON) and transmit the packaged data back to the client device 110 or to external systems for integration into the service operator's 150 workflows.

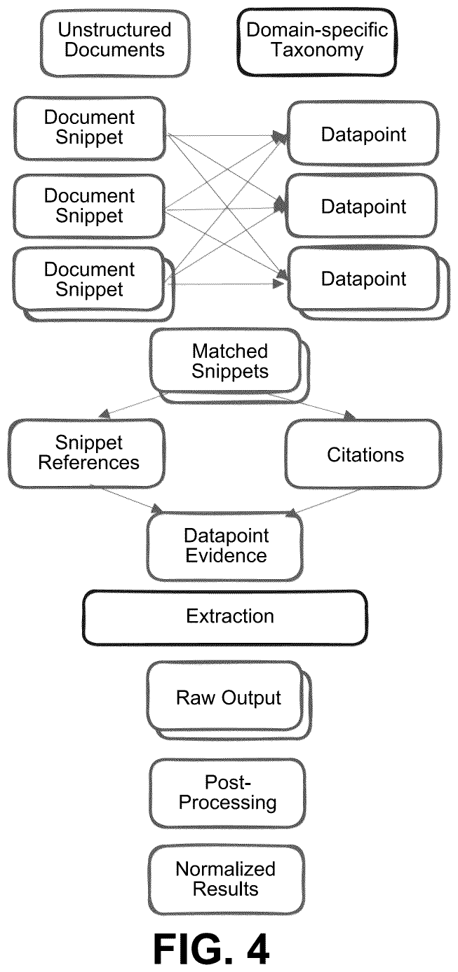

Referring to FIG. 4, a conceptual diagram illustrates how the intelligence platform 140 may map unstructured source material to a domain-specific taxonomy and then transform the resulting evidence into normalized datapoint values. FIG. 4 illustrates that unstructured documents may be partitioned into discrete snippets, paragraphs, clauses, table rows or other logical units, by the segmentation and embedding module 235. Further, FIG. 4 shows that the domain-specific taxonomy may define a set of datapoints. For each datapoint, the taxonomy may include extraction metadata (e.g., data 222) specifying the type of evidence expected, permissible answer formats and any parent-child relationships. During a candidate extraction pass, the semantic search module 245 may retrieve snippets whose embeddings are semantically similar to a query derived from the datapoint and its extraction metadata, and those snippets may be tentatively matched to their corresponding datapoints. FIG. 4 shows that because a given snippet can contain information relevant to multiple datapoints, and a datapoint may draw on evidence from multiple snippets, the matching process may produces a many-to-many mapping that is stored along with similarity scores and positional metadata. The matched snippets may then be assembled into a body of evidence for each datapoint, accompanied by snippet references and textual citations to the original documents.

Once the evidence is aggregated, the extraction orchestrator 260 may invoke the AI extraction service (e.g., the prompt generation module 250, the model integration module 255) to interpret the snippets and generate a raw answer for each datapoint. For instance, the prompt generation module 250 may construct a query that includes the text of the matched snippets along with instructions from the taxonomy, and the model integration module 255 may call a large language model to return candidate values and their supporting spans. These candidate values may form the raw output shown in FIG. 4. A post processing stage may then (e.g., using a LLM or programmatically) evaluate the candidate values, remove duplicates, enforce category constraints, resolve conflicts and normalizes formats. The result of this post processing may be a normalized value for each datapoint accompanied by consolidated citations to the underlying snippets and any external definitions or cross-references used to derive the answer. As depicted in FIG. 4, the final normalized results may be persisted in the structured datapoint store 228 and ready for presentation to the user or for downstream analytics, visualization and comparative editing workflows.

### Example Sequence Diagram Illustrating the Adaptive, Multipass Extraction Pipeline

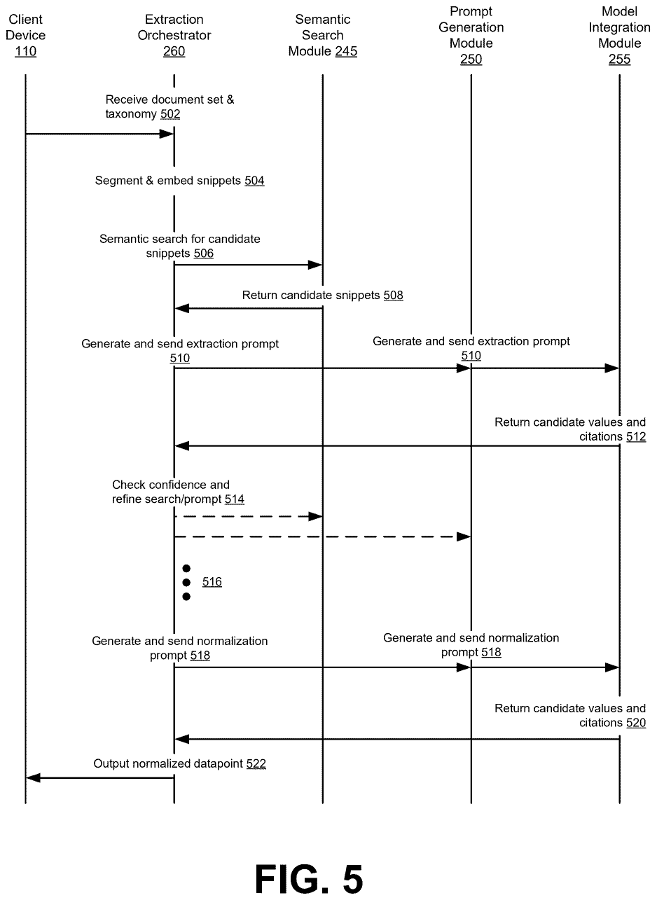

Referring to FIG. 5, a swim-lane diagram illustrates the adaptive, multipass extraction pipeline executed by the intelligence platform 140 to derive a normalized datapoint value from an uploaded document set. The process begins when a client device 110 sends the selected unstructured document set and a domain-specific taxonomy indicator to the extraction orchestrator 260 (step 502). Upon receipt, the extraction orchestrator 260 may invoke the segmentation and embedding module's 235 functionality to divide each document into snippets and generate vector embeddings for each snippet; these embeddings and associated positional metadata may be stored in the embedding index 226 and the structured datapoint store 228. This internal preprocessing step (step 504) may ensure that the platform 140 can efficiently perform semantic searches without repeatedly scanning the full text of the document set received at 502.

After preprocessing, the orchestrator 260 may initiate a structure extraction pass (not shown in FIG. 5) to generate a structure map. As shown in FIG. 5, the orchestrator 260 may also initiate a candidate extraction pass by deriving a query embedding from the extraction metadata (e.g., 222) associated with a target or current datapoint being extracted and applying any relevant structure map constraints. It passes this query to the semantic search module 245, which performs a similarity search over the embedding index 226 to identify snippets most relevant to the datapoint (step 506). The semantic search module 245 may return the ranked candidate snippets and their metadata to the orchestrator (step 508), enabling the orchestrator to assemble a context for the next phase.

To extract candidate values based on the output of step 508 received, the extraction orchestrator 260 may construct an extraction prompt that includes the text of the candidate snippets, instructions derived from the taxonomy (such as desired answer format or allowable categories) and any structure map annotations. This prompt may be forwarded to the prompt generation module 250 and then to the model integration module 255 (step 510), which may invoke the selected external or custom language model to produce one or more candidate values and their supporting citations (step 512). The orchestrator 260 may record the candidate values and citations in datastore 220 (e.g., as the structured datapoint store 228) and and compute a confidence score based on similarity metrics, agreement among multiple candidates and adherence to expected formats. If the confidence score does not meet the predetermined threshold, the orchestrator 260 may programmatically and automatically invoke submodules to adjust the scope of the semantic search or refine the prompt, for example, by narrowing the search to specific document sections or by modifying the prompt to prioritize snippets from authoritative sections, and repeat the search and extraction cycle at steps 504-514 (step 516). As part of the repetition logic, the orchestrator 260 may also select a fallback language model if the primary model fails to produce a reliable answer.

Once the orchestrator 260 determines that the candidate values meet the confidence threshold, it may initiate a normalization pass by constructing a prompt that enumerates the candidate values and their citations and directs the language model to resolve conflicts, enforce categorical answer constraints and produce a single normalized value (step 518). The model integration module 255 may return the normalized value and consolidated citations to the orchestrator (step 520), which may store this result in the structured datapoint store 228 and transmit it back to the client device 110 for display via the user interface (step 522). The output at step 522 may include both the normalized datapoint value and positional information enabling the interface on the client device 110 to highlight the supporting snippets or sections within the original documents, providing the user with transparency and traceability. By iterating through candidate extraction passes with adaptive search and prompt refinement and concluding with a normalization pass, the pipeline depicted in FIG. 5 may ensure that each datapoint is extracted accurately and efficiently.

### Example User Interfaces

Referring now to FIGS. 6A-6H, shown are screen diagrams illustrating example graphical user interfaces (GUIs) of an intelligence platform 140, in accordance with one or more embodiments. These exemplary GUIs depict how a user interacts with the platform 140 at various stages, from defining and managing domain-specific taxonomies through uploading document sets, overseeing adaptive extraction workflows, reviewing and refining extracted datapoints, visualizing aggregated insights and performing side-by-side comparisons of multiple matters.

FIG. 6A shows that the platform 140 may present on a client device 110 of a user associated with an operator 150 a taxonomy-builder interface through which the user can define or customize a taxonomy including a plurality of datapoints relevant to a particular domain or class of transactions. The GUI shown in FIG. 6A may be used to define, revise, and extend a domain-specific taxonomy used by the intelligence platform 140. A taxonomy may be pre-configured by the platform 140, for example, as a default schema for common agreement types such as credit agreements, NDAs, merger agreements or real-estate documents, or it may be created, customized, or extended by an operator 150 to address organization-specific extraction needs. The GUI of FIG. 6A may display controls for selecting a practice area and transaction subtype, which may determine the domain context in which the taxonomy will apply. Within this context, the user may specify one or more datapoints, and assign a category for each datapoint, assign a datapoint name, provide descriptive instructions regarding the semantic content the datapoint represents and indicate where such information typically appears in source documents. The user can also specify answer types (e.g., free text, date, numeric or categorical) and supply a list of permissible values; these parameters may be stored in the taxonomy and extraction metadata repository 222 and later drive the behavior of the segmentation, semantic search and normalization components of the platform 140. Upon submission, the prompt generation logic may leverage these user provided parameters to construct extraction prompts, and the model training engine 290 may incorporate the example answers into training datasets to improve recall and normalization for future extractions.

FIG. 6B illustrates a matter creation and document upload interface. In this view, the user may provide a matter name and client identifier, select a transaction type that may correspond to a user-defined or predefined domain-specific taxonomy, and upload one or more unstructured documents comprising a document set by dragging and dropping them into a window. The interface module 210 may record this metadata, write the uploaded files to the document store 224 and activate the segmentation and embedding module 235 to partition the documents into snippets and compute respective embeddings. The selected domain-specific taxonomy (e.g., “Credit Agreement” in FIG. 6B) may determine which datapoints will be extracted and which extraction parameters or metadata (such as candidate count, merge strategy and fallback models) may be loaded from the taxonomy and extraction metadata repository 222.

FIG. 6C shows a real time extraction view that communicates progress as the platform 140 transforms the uploaded documents into structured datapoints. As the extraction orchestrator 260 iteratively retrieves candidate snippets from the embedding index 226 via the semantic search module 245, constructs context aware prompts via the prompt generation module 250 and invokes external or custom language models via the model integration module 255, the interface may dynamically populate a list of datapoints with provisional and normalized values. Status indicators may reflect whether the current candidate values meet confidence thresholds or whether further refinement passes will be executed, and a progress bar may signal when segmentation, search, prompt construction or normalization operations are underway. This view may provide transparency into the adaptive, multipass extraction process while shielding the user from the underlying complexity.

FIG. 6D may present a verification and review interface in which the results of the extraction process may be displayed alongside the original documents. The left hand pane may permit navigation of the document set, while the right hand pane may list normalized datapoints grouped by category (per the hierarchy defined in the corresponding taxonomy). Each datapoint entry may include its normalized value and a citation count; selecting a datapoint may display or highlight the snippets or sections of the document set that support the datapoint value and allows the user to quickly navigate to each instance of occurrence of the datapoint value in the document set. The interface may also enable the user to verify or edit the datapoint value. Controls may further be provided for marking datapoints as accepted (verified), requesting reextraction or exporting the entire set of normalized datapoints via the data export module 285. Because each datapoint is linked back to specific snippets and a user defined or system defined taxonomy, users can confirm accuracy and traceability before the data is used for analytics or downstream workflows.

FIG. 6E shows that the GUI highlights source text corresponding to a selected datapoint. When the user clicks on a datapoint value in the review pane, the interface module 210 may retrieve the positional metadata associated with the selected datapoint from the embedding index 226 or from the structured datapoint store 228 and scroll the document viewer to the relevant page or section. The snippet containing the value may be highlighted as shown in FIG. 6E, allowing the user to see the original language from which the datapoint was derived and to understand the context in which it appears. If the highlighted text is inaccurate or incomplete, the user may edit the document text directly.

FIG. 6F depicts a control for modifying categorical datapoints via a drop down menu. For example, if the highlighted text indicates that the extracted normalized value is inaccurate, the GUI may allow the user to directly revise the strcutured value for the datapoint and propagate such corrections across the entire document set. The platform 140 may dynamically generate a dropdown of candidate values for the datapoint (e.g., based on the extracted candidate values from the candidate snippets, based on normalized, provisional or candidate values from other similar document sets sharing the same or similar taxonomy). The platform 140 may also allow the user to input a free form value for the selected datapoint. Such corrections may be recorded in the user feedback log 230 and may be incorporated into future model training or prompt refinement for automated extraction in future projects.

FIG. 6F also illustrates that when a user expands the drop down for a datapoint defined with an allowable answer set, the interface may display the set of permissible values as defined in the taxonomy (for example, “All Cash,” “Mixed Cash/Stock,” “All Stock,” etc.) or as determined based on the extraction pass. Selecting a new value may update the normalized datapoint entry in the structured datapoint store 228 and trigger the document propagation engine 272 to identify all occurrences of the corresponding datapoint in the underlying documents using positional citations, replace the text with the selected value and log the change. If the datapoint is a parent to other datapoints, the extraction orchestrator 260 may automatically reexecute extraction for those dependents so that related values remain consistent with the updated data.

FIG. 6G illustrates an analytics view that enables users to inspect and explore the structured data generated by the platform 140. The interface may list datapoints alongside their current values and provides a history panel showing previous values, edits and verifications performed by authorized users. Interactive charts and tables, rendered by the analytics and visualization module 280, may display metrics such as value distributions, verification rates and confidence scores across matters. Filters may allow the user to focus on specific categories, date ranges or confidence thresholds, while drill down functionality may reveal the underlying snippets and citations.

FIG. 6H illustrates an interactive table view that enables a user to compare and update datapoint values across multiple document sets or matters. Each row corresponds to a data point defined in the domain-specific taxonomy, and each column represents a selected matter (e.g., a current matter such as Quest and a past or model matter such as Dunkin). The interface lists the normalized values for each datapoint in the respective matters and includes left hand filters that allow the user to expand, collapse or filter datapoint categories to focus on relevant aspects of the taxonomy and deal document set. When the user highlights a datapoint row, the interface shows the normalized values extracted from each matter side by side, facilitating an intuitive comparison of the corresponding deal terms.

For a selected datapoint row, the cell for the current matter (e.g., Quest) may include a user selectable control that, when activated, may display a dynamically generated list of candidate values to allow the user to easily edit deal terms. The comparison user interface module 271 may populate this list by querying the structured datapoint store 228 for normalized values of the same datapoint across prior matters (including the Dunkin matter shown in the example of FIG. 6H), applying filters based on the allowable answer set defined in the taxonomy and ranking the results using similarity metrics (such as embedding proximity within the same domain, frequency of occurrence and recency). For example, when reviewing an “Interest Rate” datapoint in the Quest agreement, the system may retrieve normalized rates from comparable agreements, including the Dunkin deal's rate, alongside any predefined categories (such as “Fixed” or “Variable”). The user can select one of these suggestions or enter a custom value; the interface validates typed entries against the taxonomy's format and categorical constraints.

In some implementations, the comparison user interface module 271 may employs a multi-stage process to construct the list of candidate values for a selected datapoint. First, it may query the structured datapoint store 228 for all normalized values of the same datapoint across matters that share the same domain-specific taxonomy, filtering out any values that violate the extraction metadata's answer constraints (for example, values outside a numeric range, dates in an incorrect format or categorical values not in the allowable set). Next, the module 271 may apply additional context filters, such as deal type, practice area or jurisdiction, to narrow the candidates to those drawn from agreements most relevant to the current matter. The remaining candidates may then be ranked using similarity metrics that compare the current matter's context vector (derived from its embeddings and metadata) with the embedding vectors of the candidate values; weighting factors such as frequency of occurrence in prior matters, recency of the source agreement and domain-specific heuristics (e.g., regulatory compliance or prevailing economic conditions) may further refine the order. Each candidate value in the drop down may be annotated with contextual information, such as the matter name or date, to assist the user in making an informed selection.

Upon selection of a replacement value, the document propagation engine 272 may locate every occurrence of the datapoint in the current matter using positional citations stored in the structured datapoint store 228 and update each occurrence with the chosen value. It may then update the normalized datapoint record 228, log the change in the user feedback log 230 and, if necessary, trigger the extraction orchestrator 260 to reextract any dependent datapoints to ensure that related values are updated as well and remain consistent. The comparison interface thereby unifies the underlying extraction pipeline with cross matter editing, providing a seamless workflow for aligning datapoint values across matters while maintaining traceability, auditability and compliance with the taxonomy's constraints.

### Example Methods

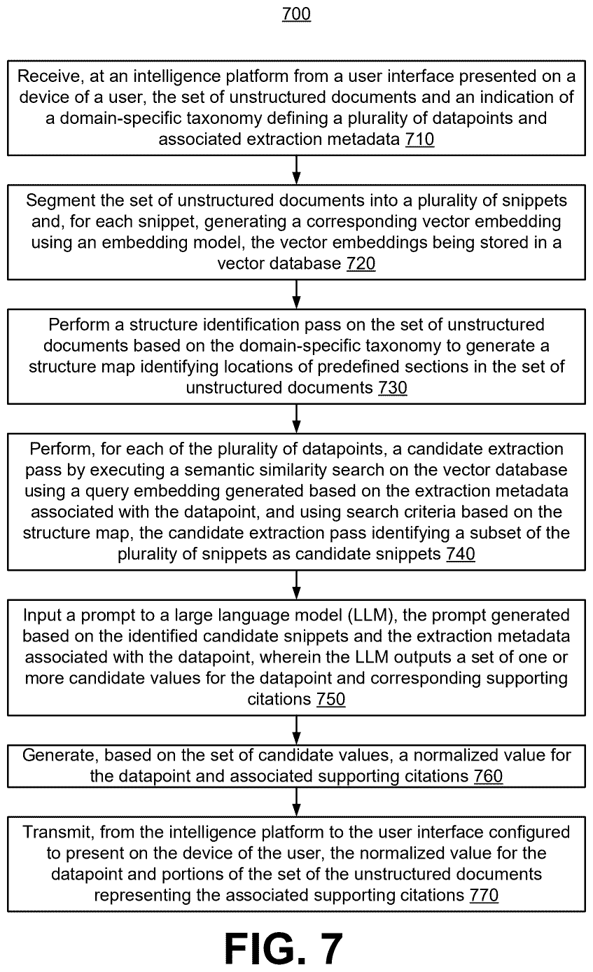

FIG. 7 is a flowchart illustrating a computer-implemented method 700 for extracting structured data from a set of unstructured documents using the intelligence platform 140, in accordance with one or more embodiments. The method 700 may be performed by coordinated operation of the interface module 210, segmentation and embedding module 235, structure identification module 240, semantic search module 245, prompt generation module 250, model integration module 255, and extraction orchestrator 260, in cooperation with data structures such as the embedding index 226 and the structured datapoint store 228. Each step may be performed automatically by these components without human intervention. Alternative embodiments may include more, fewer, or different steps from those illustrated in FIG. 7 and the steps may be executed in a different order from that shown.

At step 710, the interface module 210 may receive, from a user interface presented on a client device 110, a set of unstructured documents (for example, scanned PDFs or word processing files) and an indication of a domain-specific taxonomy defining multiple datapoints and associated extraction metadata. The taxonomy may be predefined by the platform 140 or supplied and customized by an operator 150 to capture data relevant to a particular practice area. The interface module 210 may authenticate the user, associate the uploaded document set with a new matter context and stores the raw files in the document store 224 while registering the selected taxonomy in the matter context.

At step 720, the segmentation and embedding module 235 may segment each unstructured document into a plurality of snippets, such as paragraphs, clauses or table rows, using rule-based heuristics or machine-learned boundary detectors. For each snippet, module 235 may generate a dense vector embedding by encoding the snippet with a domain-specific embedding model and write the embeddings and positional metadata (e.g., page number, character offsets) to the embedding index 226. Storing embeddings in the index may allow subsequent retrieval operations to focus on semantically relevant passages without reprocessing the full text.

At step 730, the structure identification module 240 may perform a structure identification pass on the unstructured documents to generate a structure map. Using taxonomy-defined section labels and heuristics such as heading detection, table-of-contents parsing or machine-learned classifiers, the module 240 may identify the locations of predefined sections (e.g., definitions, recitals, signature pages, termination clauses) and record their snippet ranges and confidence scores. The resulting structure map may guide downstream components by restricting the search scope to relevant sections and enabling context-aware ranking of candidate snippets.

At step 740, the extraction orchestrator 260 may initiate a candidate extraction pass for each datapoint defined in the selected taxonomy. For a given datapoint, the orchestrator 260 may derive a query embedding from the datapoint's description and other extraction metadata 222, consult the structure map to determine which document sections are most likely to contain the data and instructs the semantic search module 245 to execute a semantic similarity search against the embedding index 226. The search module 245 may apply configurable filters, such as candidate count limits and merge strategies, to identify and return a subset of snippets as candidate snippets along with their similarity scores and positional metadata. If the extraction metadata specifies that the datapoint depends on the existence or value of a parent datapoint, the orchestrator 260 may skip the search until the parent datapoint has been resolved.

At step 750, the extraction orchestrator 260 may call the prompt generation module 250 to construct a prompt for a large language model. The prompt may concatenate the text of the candidate snippets identified at step 740, instructions from the extraction metadata (for example, the expected answer format or allowable categories), and any relevant context such as the structure map. The orchestrator 260 may forward the prompt to the model integration module 255, which may invoke an external model 170 or a custom language model to produce a set of one or more candidate values for the datapoint and corresponding supporting citations. When configured, the model integration module 255 may fall back to an alternate model if the initial model fails to produce a satisfactory answer.

At step 760, the extraction orchestrator 260 may evaluate the candidate values output at step 750 using a confidence scoring module 262 and, if the confidence score meets or exceeds a predetermined threshold, initiate a normalization pass. The prompt generation module 250 may be activated by the orchestrator 260 to generate a normalization prompt that enumerates the candidate values and instructs the language model to select or synthesize a single normalized value; the model integration module 255 may return the normalized value and consolidated citations. The orchestrator 260 may enforce categorical constraints defined in the taxonomy during normalization and may resolve conflicts between competing candidate values. If confidence is insufficient, the orchestrator 260 may automatically adjust search criteria (such as narrowing or broadening search scope using the structure map), refine the prompt template or select a fallback language model and repeat the candidate extraction pass.

At step 770, the extraction orchestrator 260 may write the normalized value and its supporting citations to the structured datapoint store 228 and update the matter context. The interface module 210 may retrieve the normalized value and highlight the corresponding portions of the unstructured documents using the positional information stored in the embedding index 226 and/or store 228. The user interface on the client device 110 may display the normalized datapoint value alongside snippets from the source documents so that the user can verify or validate the extraction and, if necessary, correct or override the extracted value for the datapoint. If the user edits the value, the platform may log the correction, automatically propagate the changes to the entire document set, trigger reextraction of dependent datapoints, and the like.

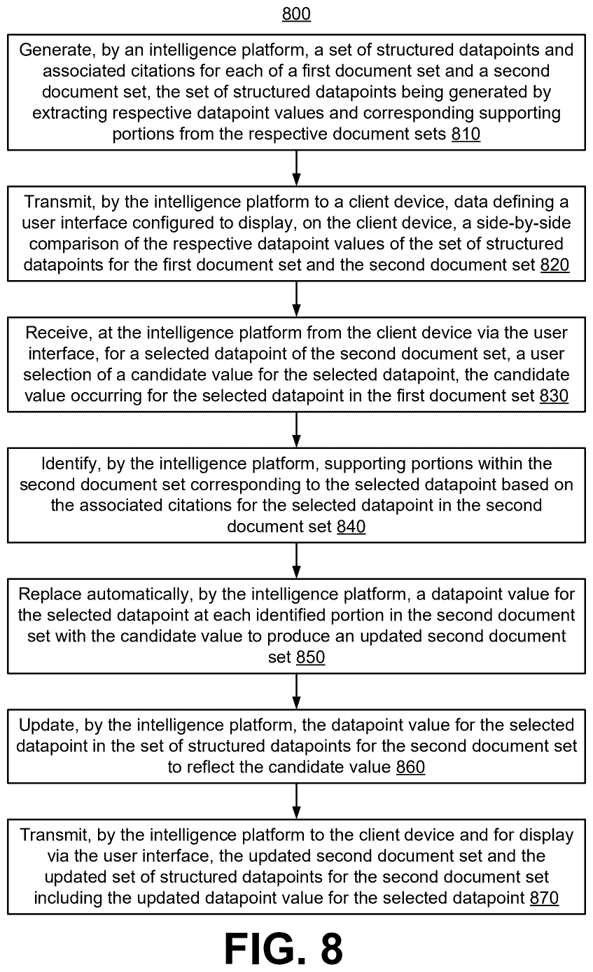

FIG. 8 is a flowchart illustrating a computer-implemented method 800 for comparative editing of datapoints across document sets, in accordance with one or more embodiments. The method 800 may be performed by an application server implementing the intelligence platform 140, and may be executed by functional components such as the interface module 210, comparative editing module 270 (including comparison user-interface module 271 and document propagation engine 272), extraction orchestrator 260 and semantic search module 245. Each step of the method may be carried out automatically by these components without human intervention, although user actions may be captured through the user interface when selecting or confirming datapoint updates. Alternative embodiments may include more, fewer or different steps, and the steps may be performed in an order different from that shown.

At step 810, the platform 140 may generate a set of structured datapoints and associated citations for each of a first document set and a second document set. To do so, the platform 140 may invoke the segmentation and embedding module 235 and extraction orchestrator 260 to segment each document into snippets, compute vector embeddings, identify relevant sections via the structure identification module 240 and apply the adaptive extraction pipeline described with reference to FIGS. 5 and 7 to extract candidate values and produce normalized values for each datapoint. The results, including the normalized values, the supporting citations and positional metadata, may be written to the structured datapoint store 228 and the embedding index 226. This step thus prepares comparable structured datasets for both document sets, enabling subsequent side-by-side analysis.

At step 820, the platform 140 may transmit data to the client device 110 that defines a user interface configured to display a side-by-side comparison of the respective datapoint values for the first and second document sets. The comparison user interface module 271 may construct a table view with rows corresponding to the datapoints defined in the taxonomy and columns corresponding to the selected matters; each cell displaying the normalized value extracted from the associated document set (e.g., see FIG. 6H). Filters or collapsible sections permit the user to focus on specific categories of datapoints, and the interface may highlight rows with differences between the values to guide attention to relevant datapoints.

At step 830, the platform 140 may receive, via the user interface, a user selection of a candidate value for a selected datapoint in the second document set. When the user interacts with the cell for a datapoint in the second column, the comparison user interface module 271 may dynamically generate a drop down menu populated with candidate values. These candidates may be obtained by querying the structured datapoint store 228 for normalized values of the same datapoint in the first document set (and potentially other matters), filtering them against the allowable answer types specified in the taxonomy and ranking them according to similarity metrics such as embedding proximity, frequency or recency. The list may also permit free form entry of a custom value, in which case the interface may validate the input against the taxonomy's constraints before accepting it.

At step 840, once a candidate value has been selected, the document propagation engine 272 may identify the supporting portions within the second document set corresponding to the selected datapoint. It may retrieve the positional metadata associated with the datapoint's citations from the structured datapoint store 228 and map these positions back to the document's text or markup. This operation may locate every occurrence of the current value of the datapoint in the second document set, ensuring that replacements occur only in relevant contexts (for example, within defined terms or schedule entries rather than in extraneous text).

At step 850, the document propagation engine 272 may automatically replace each occurrence of the selected datapoint in the second document set with the candidate value. The engine 272 may apply formatting rules to maintain the style and context of the original document, handle any necessary capitalization or punctuation adjustments and updates cross-references or definitions if required. It may simultaneously create a new version of the second document set in the document store 224, preserving a version history and enabling roll back or audit. The propagation engine 272 may also compute a confidence metric comparing the candidate value against the supporting portions; if the metric falls below a threshold, it may prompt the user to confirm or cancel the replacement.

At step 860, the platform 140 may update the structured datapoint record for the second document set to reflect the newly selected value. This update may include writing the new normalized value and consolidated citations to the structured datapoint store 228, logging the change with a timestamp and user identifier in the user feedback log 230 and marking the datapoint as modified. If the edited datapoint has dependent datapoints defined in the taxonomy, the extraction orchestrator 260 may trigger a reextraction of those dependent datapoints using the updated document context to ensure that related values remain consistent.

At step 870, the platform 140 may transmit the updated second document set and the updated structured datapoint data to the client device 110 for display via the user interface. The interface may highlight the portions of the second document that were modified, display the updated value in the comparison table and update any aggregated analytics or visualizations. Through these steps, the method 800 may enable efficient comparative editing across document sets, combining structured extraction, side-by-side analysis, dynamic value selection, automated propagation and real time updating of structured data and documents.

### Example Computer System

FIG. 9 is a block diagram illustrating components of an example machine for reading and executing instructions from a non-transitory machine-readable medium, in accordance with one or more example embodiments. Specifically, FIG. 9 shows a diagrammatic representation of one or more of the intelligence platform 140, the client device 110, and the machine for performing the processes described herein, including the methods 700 and 800, in the example form of a computer system 900.

The computer system 900 can be used to execute instructions 924 (e.g., program code or software) for causing the machine to perform any one or more of the methodologies or modules described in this disclosure. In alternative embodiments, the machine operates as a standalone device or a connected device that communicates with other machines. In a networked deployment the machine may operate in the capacity of a server machine or a client machine in a client-server environment, or as a peer machine in a peer-to-peer (or distributed) network environment.

The machine may be a server computer, a client computer, a personal computer, a tablet computer, a set-top box, a smartphone, an internet-of-things appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes one or more processing units (generally processor 902). The processor 902 may include, for example, a central processing unit, a graphics processing unit, a digital signal processor, a control system, a state machine, one or more application-specific integrated circuits, one or more radio-frequency integrated circuits or any combination of these. The computer system 900 also includes a main memory 904. The computer system 900 may further include a storage unit 916. The processor 902, memory 904 and the storage unit 916 communicate via a bus 908.

In addition, the computer system 900 may include a static memory 906, a graphics display 910 (for example, to drive a plasma display panel, a liquid crystal display or a projector). The computer system 900 may also include an alphanumeric input device 912 (for example, a keyboard), a cursor control device 917 (for example, a mouse, a trackball, a joystick, a motion sensor or other pointing instrument), a signal generation device 918 (for example, a speaker) and a network interface device 920, which are also configured to communicate via the bus 908.

The storage unit 916 includes a machine-readable medium 922 on which are stored instructions 924 embodying any one or more of the methodologies or functions described herein. For example, the instructions 924 may include the functionalities of modules of the intelligence platform 140 or the client devices 110 or the machine for performing the processes described herein, including the methods 700 and 800. The instructions 924 may also reside, completely or at least partially, within the main memory 904 or within the processor 902 (for example, within a processor's cache memory) during execution thereof by the computer system 900. The main memory 904 and the processor 902 also constitute machine-readable media. The instructions 924 may be transmitted or received over a network 926 via the network interface device 920.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method for extracting structured data from a set of one or more unstructured documents, the method comprising:
receiving, at an intelligence platform from a user interface presented on a device of a user, the set of unstructured documents and an indication of a domain-specific taxonomy defining a plurality of datapoints and associated extraction metadata;
segmenting the set of unstructured documents into a plurality of snippets and, for each snippet, generating a corresponding vector embedding using an embedding model, the vector embeddings being stored in a vector database;
performing a structure identification pass on the set of unstructured documents based on the domain-specific taxonomy to generate a structure map identifying locations of predefined sections in the set of unstructured documents;
performing, for each of the plurality of datapoints, a candidate extraction pass by executing a semantic similarity search on the vector database using a query embedding generated based on the extraction metadata associated with the datapoint, and using search criteria based on the structure map, the candidate extraction pass identifying a subset of the plurality of snippets as candidate snippets;
inputting a prompt to a large language model (LLM), the prompt generated based on the identified candidate snippets and the extraction metadata associated with the datapoint, wherein the LLM outputs a set of one or more candidate values for the datapoint and corresponding supporting citations;
generating, based on the set of candidate values, a normalized value for the datapoint and associated supporting citations; and
transmitting, from the intelligence platform to the user interface configured to present on the device of the user, the normalized value for the datapoint and portions of the set of the unstructured documents representing the associated supporting citations.

2. The computer-implemented method of claim 1, further comprising:
determining automatically that a confidence score for the set of one or more candidate values for the datapoint does not meet a predetermined threshold; and
based on the determination, modifying automatically one or both of the search criteria for the semantic similarity search and the generated prompt for the LLM to generate an updated set of one or more candidate values for the datapoint and corresponding supporting citations.

3. The computer-implemented method of claim 2, further comprising:
in response to determining that the confidence score for the updated set of one or more candidate values for the datapoint meets the predetermined threshold, inputting automatically another prompt to the LLM, the other prompt generated based on the updated set of candidate values for the datapoint and the corresponding supporting citations, wherein the LLM outputs the normalized value for the datapoint and the associated supporting citations.

4. The computer-implemented method of claim 2, wherein modifying automatically the search criteria for the semantic similarity search comprises:
narrowing a scope of the semantic similarity search to one or more predefined sections of the set of unstructured documents based on one or more locations identified in the structure map as being associated with the extraction metadata of the datapoint.

5. The computer-implemented method of claim 2, wherein modifying automatically the generated prompt for the LLM comprises:
updating the prompt to cause the LLM to prioritize candidate snippets determined to belong to one or more predefined sections of the set of unstructured documents that correspond to one or more locations identified in the structure map as being associated with the extraction metadata of the datapoint.

6. The computer-implemented method of claim 1, further comprising:
in response to determining that the confidence score for the set of one or more candidate values for the datapoint does not meet the predetermined threshold, selecting automatically a fallback LLM specified in the extraction metadata for the datapoint and using the fallback LLM to generate the updated set of one or more candidate values for the datapoint.

7. The computer-implemented method of claim 1, wherein performing the candidate extraction pass for a first datapoint is conditioned on (i) existence of a value for a second datapoint identified in the extraction metadata for the second datapoint as a parent of the first datapoint, and (ii) the second datapoint having a specified value set forth in the extraction metadata for the second datapoint.

8. The computer-implemented method of claim 1, wherein generating the normalized value for the datapoint further comprises enforcing that the normalized value conforms to a predefined set of allowable answers specified in the extraction metadata for the datapoint.

9. The computer-implemented method of claim 1, wherein the vector metadata stored in the vector database includes positional information identifying where each snippet occurs within the set of unstructured documents, and wherein transmitting the normalized value comprises highlighting, within the user interface, the portions representing the associated supporting citations based on the positional information.

10. The computer-implemented method of claim 1, further comprising:
prior to performing a subsequent extraction pass, determining, by a scheduler executing on the intelligence platform, whether to execute or skip the subsequent extraction pass based on set-level or extraction-level metrics, wherein the scheduler selectively omits the subsequent extraction pass when the metrics indicate that a previous extraction pass produces the normalized value for the datapoint that meets a quality threshold.

11. A non-transitory computer-readable storage medium storing instructions that, when executed by one or more processors, cause an intelligence platform to perform operations comprising:
receiving, at the intelligence platform from a user interface presented on a device of a user, a set of one or more unstructured documents and an indication of a domain-specific taxonomy defining a plurality of datapoints and associated extraction metadata;
segmenting the set of unstructured documents into a plurality of snippets and, for each snippet, generating a corresponding vector embedding using an embedding model, the vector embeddings being stored in a vector database;
performing a structure identification pass on the set of unstructured documents based on the domain-specific taxonomy to generate a structure map identifying locations of predefined sections in the set of unstructured documents;
performing, for each of the plurality of datapoints, a candidate extraction pass by executing a semantic similarity search on the vector database using a query embedding generated based on the extraction metadata associated with the datapoint, and using search criteria based on the structure map, the candidate extraction pass identifying a subset of the plurality of snippets as candidate snippets;
inputting a prompt to a large language model (LLM), the prompt generated based on the identified candidate snippets and the extraction metadata associated with the datapoint, wherein the LLM outputs a set of one or more candidate values for the datapoint and corresponding supporting citations;
generating, based on the set of candidate values, a normalized value for the datapoint and associated supporting citations; and
transmitting, from the intelligence platform to the user interface configured to present on the device of the user, the normalized value for the datapoint and portions of the set of the unstructured documents representing the associated supporting citations.

12. The non-transitory computer-readable storage medium of claim 11, wherein the instructions further cause the intelligence platform to perform operations comprising:
determining automatically that a confidence score for the set of one or more candidate values for the datapoint does not meet a predetermined threshold; and
based on the determination, modifying automatically one or both of the search criteria for the semantic similarity search and the generated prompt for the LLM to generate an updated set of one or more candidate values for the datapoint and corresponding supporting citations.

13. The non-transitory computer-readable storage medium of claim 12, wherein the instructions further cause the intelligence platform to perform an operation comprising:
in response to determining that the confidence score for the updated set of one or more candidate values for the datapoint meets the predetermined threshold, inputting automatically another prompt to the LLM, the other prompt generated based on the updated set of candidate values for the datapoint and the corresponding supporting citations, wherein the LLM outputs the normalized value for the datapoint and the associated supporting citations.

14. The non-transitory computer-readable storage medium of claim 12, wherein modifying automatically the search criteria for the semantic similarity search comprises:
narrowing a scope of the semantic similarity search to one or more predefined sections of the set of unstructured documents based on one or more locations identified in the structure map as being associated with the extraction metadata of the datapoint.

15. The non-transitory computer-readable storage medium of claim 12, wherein modifying automatically the generated prompt for the LLM comprises:
updating the prompt to cause the LLM to prioritize candidate snippets determined to belong to one or more predefined sections of the set of unstructured documents that correspond to one or more locations identified in the structure map as being associated with the extraction metadata of the datapoint.

16. The non-transitory computer-readable storage medium of claim 11, wherein the instructions further cause the intelligence platform to perform an operation comprising:
in response to determining that the confidence score for the set of one or more candidate values for the datapoint does not meet the predetermined threshold, selecting automatically a fallback LLM specified in the extraction metadata for the datapoint and using the fallback LLM to generate the updated set of one or more candidate values for the datapoint.

17. The non-transitory computer-readable storage medium of claim 11, wherein performing the candidate extraction pass for a first datapoint is conditioned on (i) existence of a value for a second datapoint identified in the extraction metadata for the second datapoint as a parent of the first datapoint, and (ii) the second datapoint having a specified value set forth in the extraction metadata for the second datapoint.

18. The non-transitory computer-readable storage medium of claim 11, wherein generating the normalized value for the datapoint further comprises enforcing that the normalized value conforms to a predefined set of allowable answers specified in the extraction metadata for the datapoint.

19. The non-transitory computer-readable storage medium of claim 11, wherein the vector metadata stored in the vector database includes positional information identifying where each snippet occurs within the set of unstructured documents, and wherein transmitting the normalized value comprises highlighting, within the user interface, the portions representing the associated supporting citations based on the positional information.

20. An intelligence platform, comprising:
at least one memory; and
at least one processor coupled with the at least one memory, the at least one memory storing code comprising instructions that, when executed by the at least one processor, cause the intelligence platform to perform operations comprising:
receiving, from a user interface presented on a device of a user, a set of one or more unstructured documents and an indication of a domain-specific taxonomy defining a plurality of datapoints and associated extraction metadata;
segmenting the set of unstructured documents into a plurality of snippets and, for each snippet, generating a corresponding vector embedding using an embedding model, the vector embeddings being stored in a vector database;
performing a structure identification pass on the set of unstructured documents based on the domain-specific taxonomy to generate a structure map identifying locations of predefined sections in the set of unstructured documents;
performing, for each of the plurality of datapoints, a candidate extraction pass by executing a semantic similarity search on the vector database using a query embedding generated based on the extraction metadata associated with the datapoint, and using search criteria based on the structure map, the candidate extraction pass identifying a subset of the plurality of snippets as candidate snippets;
inputting a prompt to a large language model (LLM), the prompt generated based on the identified candidate snippets and the extraction metadata associated with the datapoint, wherein the LLM outputs a set of one or more candidate values for the datapoint and corresponding supporting citations;
generating, based on the set of candidate values, a normalized value for the datapoint and associated supporting citations; and
transmitting, from the intelligence platform to the user interface configured to present on the device of the user, the normalized value for the datapoint and portions of the set of the unstructured documents representing the associated supporting citations.
